(19) United States
(12) Patent Application Publication
(10) Pub. No.: US 2026/0338125 A1
(43) Pub. Date: Oct. 29, 2026

(54) DUAL FUEL ENGINE SYSTEM AND METHOD FOR CONTROLLING DUAL FUEL ENGINE SYSTEM

(71) Applicant: Cummins Power Generation Inc., Minneapolis, MN (US)

(72) Inventors: Travis Alva Anderson, Columbus, IN (US); Axel O. zur Loye, Battle Ground, WA (US); Mark A. Rosswurm, Columbus, IN (US); Paul Daniel Borisuk, Nashville, IN (US); Shashank Bishnoi, Columbus, IN (US); Matthew W. Isaacs, Moncks Corner, SC (US); Jason A. Gore, Highland Village, TX (US); Atin Tandon, Greenwood, IN (US); Jamie Robert John Sleigh, Chester le Street (GB)

(73) Assignee: Cummins Power Generation Inc., Minneapolis, MN (US)

(21) Appl. No.: 19/111,727

(22) PCT Filed: Sep. 13, 2023
(86) PCT No.: PCT/US2023/032654

§ 371 Date: Mar. 13, 2025

Related U.S. Application Data
(63) Continuation-in-part of application No. 17/944,900, filed on Sep. 14, 2022, now Pat. No. 12,168,962.
Application No. 17/944,900 is a continuation-in-part of application No. 17/944,905, filed on Sep. 14, 2022, now Pat. No. 12,055,105.
Application No. 17/944,905 is a continuation-in-part of application No. 17/944,910, filed on Sep. 14, 2022, now Pat. No. 11,873,772.

(51) Int. Cl. F02D 41/00; F02D 41/14; F02D 41/24

(52) U.S. Cl. CPC F02D 41/0025; F02D 41/1446; F02D 41/2422; F02D 2200/0602; F02D 2200/0606; F02D 2200/0611; F02D 2200/1002; F02D 2200/101

(57) ABSTRACT

A method for controlling a dual fuel engine system includes estimating a total indicated engine load, where the total indicated engine load is based on a sum of a measured engine power and a power loss estimate. The method further includes determining a total fueling amount based on an engine speed and the total indicated engine load, where the total fueling amount includes a fueling amount for a first fuel and a fueling amount for a second fuel. The method also includes controlling the dual fuel engine system using the total fueling amount.

### CROSS-REFERENCE TO RELATED APPLICATIONS

This application claims priority to U.S. patent application Ser. No. 17/944,910, Ser. No. 17/944,900, and Ser. No. 17/944,905, each of which was filed on Sep. 14, 2022, and the entire contents of each of which are incorporated herein by reference.

### BACKGROUND

The present disclosure relates generally to methods for controlling a dual fuel engine system.

Generally, a dual fuel engine system can include an original equipment manufacturer (OEM) machine control system, a base engine control system or module (ECM) operatively coupled to the OEM, and a gas control system operatively coupled to both the OEM machine control system and the base engine control system.

### SUMMARY

One aspect of the disclosure relates to a method for controlling a dual fuel engine system. The method includes estimating a total indicated engine load, the total indicated engine load being based on a sum of a measured engine power and a power loss estimate. The method further includes determining a total fueling amount based on an engine speed and the total indicated engine load, the total fueling amount including a fueling amount for the first fuel and a fueling amount for the second fuel. The method also includes controlling the dual fuel engine system using the total fueling amount.

Another aspect of the present disclosure relates to a method for controlling a dual fuel engine system. The method includes estimating a total indicated engine load, where the total indicated engine load is based on a sum of a measured engine power, a friction power estimate, and an accessory power estimate. The method further includes determining a total fueling amount from a first look-up table, where the look-up table is based on an engine speed and the total indicated engine load. The method also includes determining at least one updated total fueling amount based on the total fueling amount and an operational state of a dual fuel mode switch within the dual fuel engine system. The method further includes determining a control input for at least one actuator within the dual fuel engine system, where the control input is based on selecting a corresponding set of look-up tables associated with the at least one actuator, where the look-up table set includes a plurality of look-up tables, and where each of the plurality of look-up tables is based on the engine speed and the at least one updated total fueling amount.

Another aspect of the present disclosure relates to a dual fuel engine system. The system includes an internal combustion engine operable in a dual fueling mode, at least one actuator operably coupled to the internal combustion engine, and at least one controller in communication with the internal combustion engine and the at least one actuator. The at least one controller is configured to receive a first input corresponding to an engine speed and a second input corresponding to a measured engine power, calculate a power loss estimate, determine a total fueling amount based on the measured engine power and a power loss estimate, determine a first fuel command for the first fuel associated with the internal combustion engine based on at least a calculated speed governor command and the power loss estimate, and determine at least one updated total fueling amount based on the total fueling amount and the first fuel command for the first fuel. The at least one controller is further configured to select a look-up table set associated with the at least one actuator based on a second fuel substitution rate associated with the internal combustion engine, where the look-up table set is based on the engine speed and the at least one updated total fueling amount, and send an input to the at least one actuator based on the look-up table set.

One aspect of the present disclosure relates to a method for controlling a dual fuel engine system configured to operate using a first fuel and a second fuel. The method includes determining a friction power loss amount of an internal combustion engine of the dual fuel engine system, where the friction power loss amount is based on an engine speed of the internal combustion engine and a friction torque estimate. The method further includes determining an accessory power loss amount of a power of the internal combustion engine, where the accessory power loss amount is based on the engine speed and an accessory torque estimate. The method also includes estimating a net engine power amount based on the accessory power loss amount and a brake power amount of the internal combustion engine. The method also includes estimating an indicated power for the first fuel and estimating, based on the estimated net engine power, a first indicated engine power and a first power for the second fuel.

Another aspect of the present disclosure relates to a method for controlling a dual fuel engine system configured to operate using a first fuel and a second fuel. The method includes estimating a net engine power amount of an internal combustion engine of the dual fuel engine system based on an accessory power loss amount of a power of the internal combustion engine, and a brake power estimate of the internal combustion engine. The method also includes determining a first total indicated engine power based on the net engine power and a friction power loss amount of the internal combustion engine. The method further includes determining a lower heating value (LHV) for the second fuel within the internal combustion engine, where the LHV is a measured value or an estimated value. The method also includes estimating a second total indicated engine power based on the LHV, a total flow estimate for the second fuel, and a power estimate for the first fuel. The method further includes activating at least one engine protective measure based on a difference between the first total indicated engine power and the second total indicated engine power being greater than a predetermined threshold.

Yet another aspect of the present disclosure relates to a dual fuel engine system operable in a dual fueling mode. The system includes at least one controller in communication with an internal combustion engine, where the internal combustion engine is configured to operate using a first fuel and a second fuel. The at least one controller is configured to receive an input corresponding to an engine speed of the internal combustion engine, receive an input for calculating a net engine power estimate, and calculate a percent rated power of the internal combustion engine based on the engine speed and the net engine power estimate. The at least one controller is further configured to determine a base substitution rate target of the second fuel for the internal combustion engine based on the engine speed, the percent rated power, an intake manifold temperature within the internal combustion engine, and a knock propensity index estimate within the internal combustion engine. The at least one controller is also configured to determine a second fuel power target for the internal combustion engine based on the base substitution rate target of the second fuel and a first indicated engine power estimate.

One aspect of the present disclosure relates to a method for controlling a dual fuel engine system configured to operate using a first fuel and a second fuel. The method includes determining a flow target of the second fuel for an internal combustion engine of the dual fuel engine system, where the flow target of the second fuel is based on a power target of the second fuel of the internal combustion engine, a thermal efficiency estimate of the internal combustion engine, and a lower heating value (LHV) within the internal combustion engine. The method also includes adjusting the flow target of the second fuel based on at least one of a measured second fuel temperature or a measured second fuel injector pressure. The method further includes determining at least one base second fuel injector command based on the adjusted flow target of the second fuel, a second fuel substitution rate estimate, and a second fuel substitution rate target. The method also includes determining, based on the at least one base second fuel injector command, a second fuel injector command for at least one engine bank.

Another aspect of the present disclosure relates to a dual fuel engine system for an internal combusting engine configured to operate using a first fuel and a second fuel. The dual fuel engine system includes at least one injector for the second fuel operably coupled to the internal combustion engine having a left bank and a right bank, where the internal combustion engine is operable in a dual fuel mode. The dual fuel engine system also includes at least one proportional-integral-derivative (PID) controller communicably coupled to the internal combustion engine and the at least one injector for the second fuel. The at least one PID controller is configured to receive a feedforward input, a second fuel substitution rate estimate, and a second fuel substitution rate target. The at least one PID controller is further configured to output, based on the feedforward input, at least one injector command for the second fuel, and bias the at least one injector command for the second fuel to each of the right bank and the left bank based on an exhaust temperature difference associated with each of the right bank and the left bank.

Yet another aspect of the present disclosure relates to a dual fuel engine system operable in a dual fuel mode. The dual fuel engine system includes an internal combustion engine having at least one engine bank, where the internal combustion engine is configured to operate using a first fuel and a second fuel. The dual fuel engine system also includes at least one injector for the second fuel operably coupled to the internal combustion engine, and at least one controller communicably coupled to the internal combustion engine and the at least one injector for the second fuel. The at least one controller is configured to determine a second fuel flow target for the internal combustion engine, where the second fuel flow target is based on a second fuel power target of the internal combustion engine, a thermal efficiency estimate of the internal combustion engine, and a lower heating value (LHV) within the internal combustion engine. The at least one controller is further configured to adjust the second fuel flow target based on at least one of a measured second fuel temperature or a measured second fuel injector pressure to determine an adjusted second fuel flow target for the dual fuel mode. The at least one controller is also configured to determine at least one base second fuel injector command based on the adjusted second fuel flow target, a substitution rate estimate for the second fuel, and a substitution rate target for the second fuel. The at least one controller is further configured to determine, based on the at least one base second fuel injector command, an injector command for the second fuel for the at least one engine bank.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block diagram of a dual fuel engine system, according to an exemplary embodiment.

FIG. 2 is a block diagram of a control system of the dual fuel engine system of FIG. 1, according to an exemplary embodiment.

FIG. 3 is a flow diagram illustrating a method carried out by the control system of FIG. 2, according to an exemplary embodiment.

FIG. 4 is a flow diagram illustrating a method carried out by the control system of FIG. 2, according to an exemplary embodiment.

FIG. 5 is a flow diagram illustrating a method carried out by the control system of FIG. 2, according to an exemplary embodiment.

FIG. 6 is a flow diagram illustrating a method carried out by the control system of FIG. 2, according to an exemplary embodiment.

FIG. 7 is a flow diagram illustrating a method carried out by the control system of FIG. 2, according to an exemplary embodiment.

FIG. 8 is a flow diagram illustrating a method carried out by the control system of FIG. 2, according to an exemplary embodiment.

FIG. 9 is a flow diagram illustrating a method carried out by the control system of FIG. 2, according to an exemplary embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are contemplated and made part of this disclosure.

The present disclosure pertains at least in part to systems and methods providing for reduced operating cost, improved efficiency and/or improved performance of a dual fuel engine system. In some embodiments, such systems and methods allow for meeting target emission levels. In some embodiments, protocols for control of the dual fuel system are adjustable to streamline interfacing among, for example, a diesel engine ECM, gas controllers, and OEM controllers. In various embodiments, the dual fuel engine system (and associated methods of operation) is tailored to maximize the use of a less-expensive gas fuel and minimize the use of diesel fuel while meeting performance and emissions requirements and maintaining robust engine protection. In particular, to meet Tier 4 emissions regulations with a dual fuel engine system, precise and robust control of a dual fuel engine system is needed. Such precise and robust control includes, but is not limited to, control of a gas or liquid fuel system, a second fuel type system (e.g., diesel, gas, etc.), and aftertreatment system included within the dual fuel engine system. The present disclosure outlines a system and method for precise and robust control of a dual fuel engine system including accurately determining (e.g., by measuring or estimating) multiple engine parameters (e.g., brake power, friction power, accessory power, a first fuel (e.g., diesel, gas, liquid fuel) power, a second fuel (e.g., gas, liquid) power, a second fuel (e.g., gas, liquid) substitution rate, fuel quality parameter associated with the second fuel (e.g., methane number), LHV, a second fuel (e.g., gas, liquid) temperature, a second fuel (e.g., gas, liquid) pressure, knock intensity, exhaust temperature, etc.) and using the determined parameters as inputs for determining appropriate commands for one or more actuators within the dual fuel engine system. The system and methods described herein are applicable to new engine builds or for retrofitting onto existing Tier 4 diesel engine systems. Advantageously, the systems and methods described herein are lower in cost and complexity as compared to typical port gas injection or cylinder pressure sensing systems.

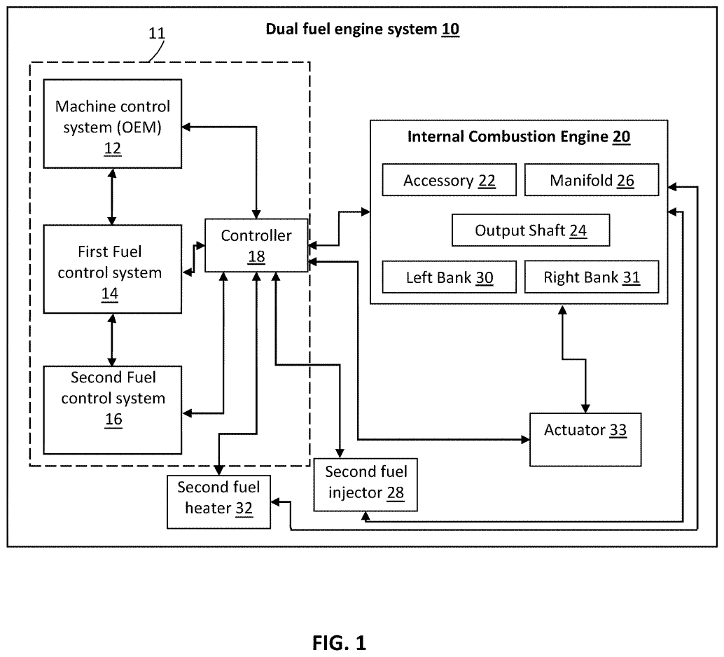

Referring to FIG. 1, a block diagram of a dual fuel engine system 10 is shown, according to an exemplary embodiment. The dual fuel engine system 10 is configured to be an engine having a dual fuel operation mode, the engine configured to operate using two different fuels. The engine can be configured to operate using a first fuel and a second fuel, where the first fuel and the second fuel have different properties and/or chemical compositions. The properties can include auto-ignition temperatures, flame speeds, etc. The fuels can include diesel and natural gas, for example. For example, the first fuel can be a diesel fuel. The second fuel can be, for example, natural gas, an e-fuel or liquid biofuel. The liquid biofuel can be methanol and/or ethanol, for example. The first fuel or the second fuel can be any one of a high cetane number fuel, such as diesel, gas-to-liquid (GTL) diesel, heavy fuel oil (HFO), low sulfur fuel oil (LFSO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, or oxymethylene ether (OME), or a low cetane number fuel (e.g., a high octane number fuel, a high methane number fuel). The low cetane number fuel can be natural gas, hydrogen, ethane, propane, butane, syngas, ammonia, methanol, ethanol, or gasoline. The first fuel and/or the second fuel can optionally be a blend of fuels. It should be appreciated that the foregoing are merely examples of fuels, and other types of first and second fuels are not precluded. In various embodiments, the dual fuel engine system 10 is configured for one or more oil and gas production applications (e.g., land based oil and/or gas drilling and hydraulic fracturing).

As shown in FIG. 1, the dual fuel engine system includes an internal combustion engine 20, which is operably coupled to a control system 11 via at least one controller 18. The control system 11, which includes a machine control system (OEM system) 12, a first fuel control system 14, and a second fuel control system 16, is configured to send one or more inputs to the controller 18, where the controller 18 then controls the internal combustion engine 20. In various embodiments the first fuel control system 14 and its components are configured to operate using the first fuel. In other embodiments, the second fuel control system 16 and its components are configured to operate using the second fuel. For example, in various embodiments, the first fuel control system 14 is a diesel control system and the second fuel control system 16 is a gas control system. In other embodiments, the first fuel control system 14 is a first gas control system and the second fuel control system 16 is a second gas control system. In yet other embodiments, one or both of the first fuel control system 14 and the second fuel control system 16 can be liquid fuel control systems.

In yet other embodiments, the first fuel control system 14 and its components are configured to operate using the second fuel and the second fuel control system 16 and its components are configured to operate using the first fuel. In yet other embodiments, each of the first fuel control system 14 and the second fuel control system 16 and their respective components can selectively operate using either the first fuel or the second fuel. In various embodiments, the first fuel control system 14 and the second fuel control system 16 cooperatively operate within the internal combustion engine 20.

In various embodiments, the controller 18 is configured to include a processor and a non-transitory computer readable medium (e.g., a memory device) having computer-readable instructions stored thereon that, when executed by the processor, cause the at least one controller 18 to carry out one or more operations. In various embodiments, the at least one controller 18 is a computing device (e.g., a microcomputer, microcontroller, or microprocessor). In other embodiments, the at least one controller 18 is configured as part of a data cloud computing system configured to receive commands from a user control device and/or remote computing device.

The following description generally relates to a system in which the first fuel control system 14 operates using the first fuel and the second fuel control system 16 operates using the second fuel, however, it should be understood that in other embodiments, each of the first and second fuel control system 14, 16 can be selectively configured to operate using either the first fuel or the second fuel, as described above. The controller 18 is also operably coupled to at least one second fuel injector 28 to facilitate injection of the second fuel, at least one second fuel heater 32 structured to heat the second fuel, and at least one actuator 33. In some embodiments, the second fuel injector 28 is a gas injector. In other embodiments, the second fuel injector 28 is a liquid fuel injector. In various embodiments, the at least one second fuel heater 32 is a gas heater, configured to heat gas. In some embodiments, the at least one second fuel heater 32 is a liquid fuel heater configured to heat liquid fuel. In other embodiments, the dual fuel engine system 10 does not include a second fuel heater. In some embodiments, each of the second fuel injector 28, the heater 32, and the actuator 33 are operably coupled to the internal combustion engine 20. In various embodiments, the second fuel injector 28 is configured to control or facilitate injection of the second fuel (e.g., gas or a liquid, or a second gas) into the internal combustion engine 20. The at least one second fuel heater 32 is configured to adjust a temperature of the second fuel flowing within the internal combustion engine 20. The actuator 33 can include one or more first fuel type (e.g., diesel type or other liquid type, first gas type) actuators, air handling actuators, aftertreatment actuators, or any other type of actuator within the dual fuel engine system 10. Accordingly, during operation, the controller 18 can send one or more inputs to one or more of the internal combustion engine 20, the second fuel injector, 28, the heater 32, or the actuator 33 to facilitate a desired mode of operation of the dual fuel engine system 10.

As shown, the internal combustion engine 20 includes an output shaft 24 and may also include one or more accessories 22. The internal combustion engine 20 further includes at least one manifold 26. In various embodiments, the at least one manifold 26 includes, but is not limited to an intake manifold. The internal combustion engine 20 also includes at least one engine cylinder bank. In some embodiments, the at least one engine cylinder bank includes a left bank 30 and a right bank 31. During operation of the dual fuel engine system 10, the control system 11 can receive one or more inputs from a user and/or one or more sensors within the dual fuel engine system 10 and control operation of at least one of the internal combustion engine 20, the second fuel injector 28, or the actuator 33 via the controller 18.

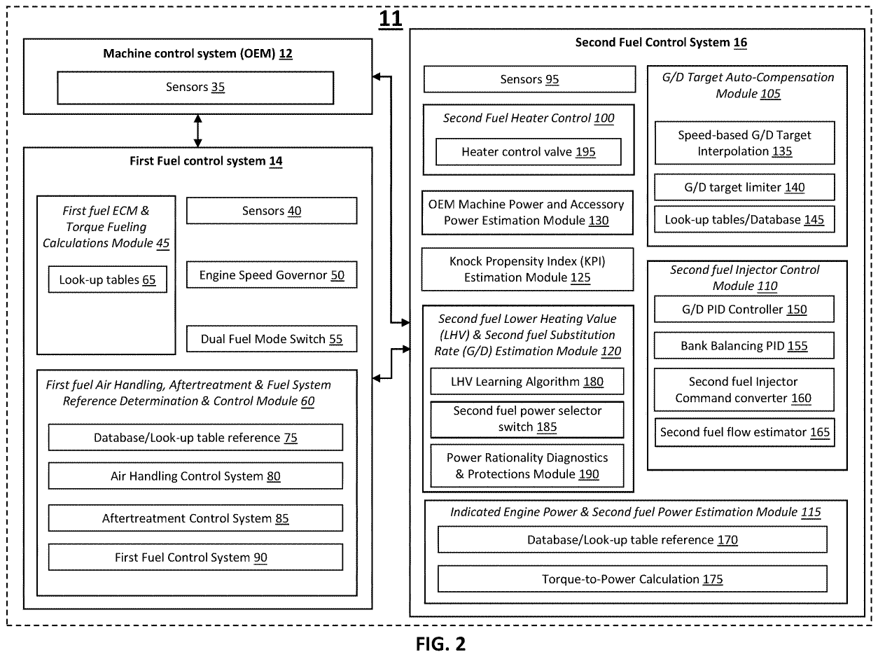

FIG. 2 is a block diagram of the control system 11 of the dual fuel engine system 10, according to an exemplary embodiment. As shown, the OEM system 12 can include one or more sensors 35, which are each coupled to one or more corresponding components within the dual engine system 10. In various embodiments, the one or more sensors 35 can be operably coupled to or in communication with a fracturing (“frac”) pump, accessories, one or more inlets or outlets of the internal combustion engine 20, or any other component within the dual fuel engine system 10 (e.g., cooling fan, flywheel, brakes, etc.). The OEM system 12 can include one or more processors configured to receive inputs from the sensors 35. In various embodiments, the one or more inputs from the sensors 35 can include a power estimate, a frac pump speed, a frac pump discharge pressure, a dual fuel mode activation request, or any other input detectable by the one or more sensors 35. As shown, the OEM system 12 is communicably coupled to each of the first fuel control system 14 and the second fuel control system 16, where the OEM system 12 can output information sensed by the one or more sensors 35 or can receive inputs from the first fuel control system 14 and/or the second fuel control system 16.

As shown in FIG. 2, the first fuel control system 14 includes one or more sensors 40, which are coupled to or disposed adjacent to one or more components within the internal combustion engine 20. In various embodiments, the one or more sensors 40 can be configured to determine (e.g., sense, detect, measure) at least one of an engine speed, an intake manifold temperature, an engine coolant temperature, an oil temperature, a cooling fan duty cycle, a first fuel (e.g., diesel, first gas, or other liquid) rate, or an operational state of a dual fuel mode switch 55. In various embodiments, the dual fuel mode switch 55 can be configured to switch operation of the internal combustion engine 20 between single or dual fuel modes. Additionally, or alternatively, the one or more sensors 40 can be configured to determine a lower heating value (LHV) of the second fuel (e.g., gas, liquid, or a second gas). In yet other embodiments, the one or more sensors 40 can be configured to determine one or more parameters indicative of the LHV, which can include, but are not limited to, a second fuel (e.g., gas, liquid, or second gas) density or a speed of sound. The first fuel control system 14 also includes an engine speed governor 50. In various embodiments, the engine speed governor 50 can include one or more controllers configured to control a speed of the internal combustion engine 20.

The first fuel (e.g., diesel or a first gas) control system 14 also includes a first fuel (e.g., diesel or a first gas) engine control system (ECM) and a torque fueling calculations module 45. In various embodiments, the torque fueling calculations module 45 can include one or more processors in communication with one or more reference databases or repositories, where the one or more processors are configured to reference data stored within the databases in order to carry out torque calculations related to the internal combustion engine 20. For example, in various embodiments, the torque fueling calculations module 45 is configured to calculate a torque based on one or more known parameters. In various embodiments, the module 45 is configured to receive inputs corresponding to a dual fuel mode operation condition, an engine friction parameter, an accessory (“parasitic”) torque parameter, engine speed, an OEM machine power estimate, and an engine accessory power estimate (e.g., gas controller, liquid fuel controller, flywheel, etc.). In various embodiments, the one or more reference databases or repositories can include look-up tables 65. In various embodiments, the one or more look-up tables 65 includes one or more chi-tables. In various embodiments, the look-up tables 65 can include reference information related to engine torque, engine speed, engine friction parameters, parasitic or accessory torque parameters, first fuel (e.g., diesel or a first gas) fuel rates, intake manifold temperatures, and/or an engine coolant temperature. In various embodiments, the engine friction parameters of the look-up tables 65 can be based on at least one of an oil temperature or a coolant temperature. In some embodiments, the parasitic or torque parameters of the look-up tables 65 can be based on a cooling fan duty cycle (i.e., of a cooling fan within the internal combustion engine 20). In various embodiments, the module 45 is configured to determine at least one of a total fueling amount of the first fuel (e.g., diesel or a first gas), an approximate equivalent total fueling amount, an equivalent total fueling amount (i.e., a second fuel fueling equivalent of the fueling amount of the first fuel), a friction torque estimate, or a first fuel rate.

The first fuel control system 14 also includes a first fuel (e.g., diesel or a first gas) air handling, aftertreatment & fuel system reference determination and control module 60. In various embodiments, the control module 60 can include at least one processor in communication with a database (e.g., look-up tables) 75. In various embodiments, the database 75 includes a data repository relating engine speed, fueling amounts (e.g., equivalent total fueling amount, approximate equivalent total fueling amount), second fuel (e.g., gas, liquid, or a second gas) substitution rate (G/D), compressor inlet density (CID), or any other related parameters. Accordingly, the one or more processors within the control module 60 are configured to reference data stored within the database 75 to determine one or more system inputs for at least one of an air handling control system 80, an aftertreatment control system 85, or a first fuel control system 90. In various embodiments, the one or more system inputs includes, but is not limited to, an actuator command, or a target (e.g., a set point, operating threshold, etc.) for at least one of the first fuel air handling control system 80, aftertreatment control system 85, or first fuel control system 90.

As shown in FIG. 2, the second fuel (e.g., gas, liquid, or a second gas) control system 16 can include one or more sensors 95, which are coupled to or disposed adjacent to one or more components within the internal combustion engine 20. In various embodiments, the one or more sensors 95 can be configured to determine (e.g., sense, detect, measure, etc.) at least one of an OEM machine torque, an accessory torque, a fuel quality parameter associated with the second fuel, a second fuel injector pressure, a second fuel supply pressure, a second fuel flow amount, an engine bank exhaust temperature, an aftertreatment system temperature, an LHV, a second fuel temperature, a dual fuel mode input, a knock intensity, G/D, or any other related parameter. In various embodiments, the fuel quality parameter associated with the second fuel can be a knock propensity indicator, or a knock propensity index. In some embodiments, the knock propensity index (KPI) can be an index that correlates a fuel composition (i.e., of the second fuel) to a knock propensity of an engine (i.e., the engine 20) operating with the fuel (i.e., the second fuel). In some embodiments, the KPI can be a methane number (MN), an octane number, an anti knock index (AKI), or any other parameter known in the art. In various embodiments, the KPI can be the MN when the second fuel is natural gas. In various embodiments, the KPI can be the octane number or the AKI when the second fuel is gasoline. In some embodiments, the engine bank exhaust temperature can correspond to a left bank average exhaust temperature and/or a right bank average exhaust temperature. In some embodiments, a bank average exhaust temperature can be calculated by averaging the measurements from individual exhaust port temperature sensors. In some embodiments, the exhaust port temperature sensors can be among the at least one sensors 35, 40, and/or 95. The second fuel control system 16 also includes an OEM machine power and accessory power estimation module 130. In various embodiments, the OEM machine power and accessory power estimation module 130 can include one or more processors configured to estimate an OEM machine power and/or accessory power based on one or more inputs received by the one or more sensors 95 (and/or from the sensors 35, 40). In some embodiments, the accessory power can be a power associated with one or more accessory components and/or output shafts (e.g., output shaft 24) within the dual fuel engine system 10. In various embodiments, the OEM machine power and accessory power estimation module 130 is configured to receive inputs related to an OEM machine power estimate, an accessory torque measurement, a pump speed, a pump discharge pressure, and an engine speed, where the one or more processors then estimate an accessory power estimate based on the inputs. Similarly, the second fuel control system 16 also includes a KPI (e.g., MN) estimation module 125. In various embodiments, the KPI estimation module 125 can include one or more processors configured to estimate a KPI associated with the internal combustion engine 20 based on one or more inputs received by the one or more sensors 95 (and/or from the sensors 35, 40). In various embodiments, at least one of the sensors 35, 40, or 95 may be assigned or partitioned to any of the different control systems (e.g., OEM system 12, first fuel control system 14, second fuel control system 16) within the dual fuel engine system 10 without changing overall functionality of the sensors. For example, in various embodiments, the sensors 95 may be included within or operably coupled to any of the OEM system 12 the first fuel control system 14, or the second fuel control system 16. Similarly, the sensors 35 may be included within or operably coupled to any of the OEM system 12, the first fuel control system 14, or the second fuel control system 16. The sensors 40 also may be included within or operably coupled to any of the OEM system 12, the first fuel control system 14, or the second fuel control system 16.

The second fuel control system 16 also includes an indicated engine power and second fuel (e.g., gas, liquid, or a second gas) estimation module 115. The engine power and second fuel estimation module 115 can include one or more processors, which are configured to receive one or more inputs related to operation of the dual fuel engine system 10. The engine power and second fuel estimation module 115 can be further configured to determine, using a database 170 and/or a torque-to-power calculation system 175, at least one of a thermal efficiency estimate, a first power estimate of the second fuel (e.g., gas, liquid, or a second gas), an indicated power estimate of the first fuel (e.g., diesel, first gas, or other liquid), a net engine power estimate, an intake manifold temperature (e.g., a maximum intake manifold temperature), and/or other related parameters. In various embodiments, the database 170 is a look-up table. In some embodiments, the torque-to-power calculation system 175 can be or include computer logic. In various embodiments, the engine power and second fuel estimation module 115 is configured to receive one or more inputs corresponding to a G/D estimate, a friction torque estimate, an accessory (“parasitic”) torque estimate, a first fuel rate, an engine speed, an intake manifold temperature, and/or a MN estimate. In embodiments, the KPI estimate is determined by the KPI module 125. Although the terms “torque” and “power” are used in various instances throughout the disclosure, it should be understood that in various embodiments, torque can be used in place of power or vice versa. For example, it should be understood that power can be calculated from torque and speed and vice versa. In yet other embodiments, any other parameter indicative of a load (e.g., alternatively or in addition to torque and/or power) can be determined and/or used in operations carried out by the control system 11.

The second fuel control system 16 also includes a second fuel (e.g., gas, liquid, or a second gas) LHV and G/D estimation module 120. The LHV and G/D estimation module 120 can include a second fuel (e.g., gas, liquid, or a second gas) power selector switch 185, a LHV learning algorithm 180 configured to process one or more received inputs, and a power rationality diagnostics and protections module 190. In various embodiments, the LHV learning algorithm 180 includes a filter (e.g., a low-pass filter, a moving average filter, etc.) and/or an adaptive learning routine. In some embodiments, the one or more inputs are received from the sensors 95. The LHV and G/D estimation module 120 can include one or more processors configured to receive inputs including a total flow estimate of the second fuel (i.e., of the second fuel flowing within the engine system 10), a thermal efficiency estimate, an indicated power estimate of the first fuel, and a first indicated engine power estimate. In various embodiments, the one or more processors of the LHV and G/D estimation module 120 can be received from the sensors 35, 40, and/or 95. The LHV and G/D estimation module 120 can consequently estimate a G/D amount and an LHV amount associated with the internal combustion engine 20. In various embodiments, the one or more processors within the LHV and G/D estimation module 120 can determine the LHV and the G/D estimate amount by multiplying the total flow estimate of the second fuel by the thermal efficiency estimate and using the result to normalize the first power estimate of the second fuel (e.g., by dividing the first power estimate of the second fuel by the product of the total flow estimate of the second fuel and the thermal efficiency estimate) to determine an instantaneous LHV amount. The LHV learning algorithm 180 can process the instantaneous LHV amount to then determine (i.e., learn) the LHV estimate. In various embodiments, the second fuel power selector switch 185 can be configured to receive inputs corresponding to first and second power estimates. In some embodiments, the second fuel power selector switch 185 can also be configured to use the first and second power estimates to output a final power estimate of the second fuel. In various embodiments, the final power estimate of the second fuel is based on a maximum or minimum of the first and second power estimates. In various embodiments, the power rationality diagnostics and protections module 190 can include one or more processors configured to receive inputs corresponding to the first and second indicated engine power estimates. In some embodiments, the power rationality diagnostics and protections module 190 is further configured to, based on and responsive to a comparison of one or both of the first and second indicated engine power estimates to one or more thresholds, initiate one or more diagnostic operations or engine protective protocols.

As shown, the second fuel control system 16 further includes a G/D target auto-compensation module 105. In various embodiments, the G/D target auto-compensation module 105 is configured to adjust or compensate the G/D target of the internal combustion engine 20. The module 105 is configured to receive one or more inputs indicating an engine speed, an engine load (e.g., power, torque, etc.), an intake manifold temperature, and/or a KPI estimate. In various embodiments, one or more inputs are received by the module 105 from the sensors 95, 35, and/or 40. In some embodiments, the one or more inputs received by the module 105 are processed by a speed-based G/D target interpolation unit 135 to determine the G/D target based on the indicated engine speed. In various embodiments, the speed-based G/D target interpolation unit 135 determines the G/D target based on the indicated engine speed by using data stored in one or more databases 145. In some embodiments, the one or more databases 145 can include one or more look-up tables. The module 105 also includes a G/D target limiter 140, which includes one or more processors configured to determine a G/D target limiting value based on one or more inputs. In various embodiments, the one or more inputs can include an engine knock, an exhaust temperature, and/or a first fuel amount. In various embodiments, the exhaust temperature corresponds to an exhaust temperature of an engine bank. The second fuel control system 16 can use the G/D target limiting value, together with a first indicated engine power estimate, to determine a second fuel power target value.

As shown in FIG. 2, the second fuel control system 16 includes a second fuel injector control module 110, which includes at least one G/D proportional-integral-derivative (PID) controller 150. In various embodiments, the PID controller 150 is configured to receive a feedforward input, the feedforward input being based on a second fuel injector pressure and a temperature compensated second fuel flow target. In various embodiments, the second fuel injector pressure and temperature can be measured by the sensors 95, 35, and/or 40. The controller 150 can also receive a feedback input corresponding to the G/D estimate and a target input corresponding to the G/D controller. Responsive to receiving the feedforward, feedback, and target inputs, the PID controller 150 can output at least one base second fuel injector command. In various embodiments, the at least one base second fuel injector command is associated with at least one engine bank second fuel injector command. In some embodiments, the at least one engine bank second fuel injector command includes a left bank second fuel injector command and/or a right bank second fuel injector command.

A second fuel injector command converter 160 can be operably coupled to the PID controller 150. In various embodiments, the second fuel injector command converter 160 can include one or more processors configured to convert the base second fuel injector command to the at least one engine bank second fuel injector command. The second fuel injector control module 110 can also include a bank balancing PID controller 155. In various embodiments, the PID controller 155 is configured to receive a feedback input corresponding to a difference in exhaust temperatures between a left bank of the internal combustion engine 20 (e.g., left bank 30) and a right bank of the internal combustion engine 20 (e.g., right bank 31), and a target value associated with the exhaust temperature difference. In various embodiments, the target value is zero. Responsive to the feedback and target inputs, the PID controller 155 is configured to output a left bank correction amount and a right bank correction amount. In various embodiments, one or both of the left and right bank correction amounts can be either positive or negative values. The output left and right bank correction amounts can be each added to the base second fuel injector command (e.g., output from the PID 150), which the second fuel injector command converter 160 can convert to the respective left and right bank second fuel injector commands. The second fuel flow estimator 165 is configured to receive each of the left and right bank second fuel injector commands, together with a second fuel pressure and a second fuel temperature. In various embodiments, the second fuel flow estimator 165 can include or be coupled to one or more processors within the module 110. In some embodiments, the second fuel pressure and/or second fuel temperature are measured by the sensors 95, 35, and/or 40. In various embodiments, the second fuel flow estimator 165 is configured to output a total second fuel flow estimate associated with the internal combustion engine 20 based on the left and right bank second fuel injector commands, the second fuel pressure, and the second fuel temperature.

Finally, as shown in FIG. 2, the second fuel control system 16 includes a second fuel heater control module 100. In various embodiments, the second fuel heater control module 100 is configured to control an operational state of the at least one heater 32 coupled to the internal combustion engine 20. In various embodiments, the second fuel heater control module 100 includes one or more processors that are configured to receive one or more inputs from the at least one controller 18 and/or from other components within the control system 11. The one or more processors within the second fuel heater control module 100 can be configured to cause the second fuel heater control module 100 to change an operational state of the at least one heater 32. In some embodiments, changing the operational state of the at least one heater 32 can include adjusting an operational setting of a heater control valve 195 to control the operational state of the at least one heater 32. In various embodiments, the at least one heater 32 can be an electric heater. In other embodiments, the at least one heater 32 can be configured to provide heat using engine coolant.

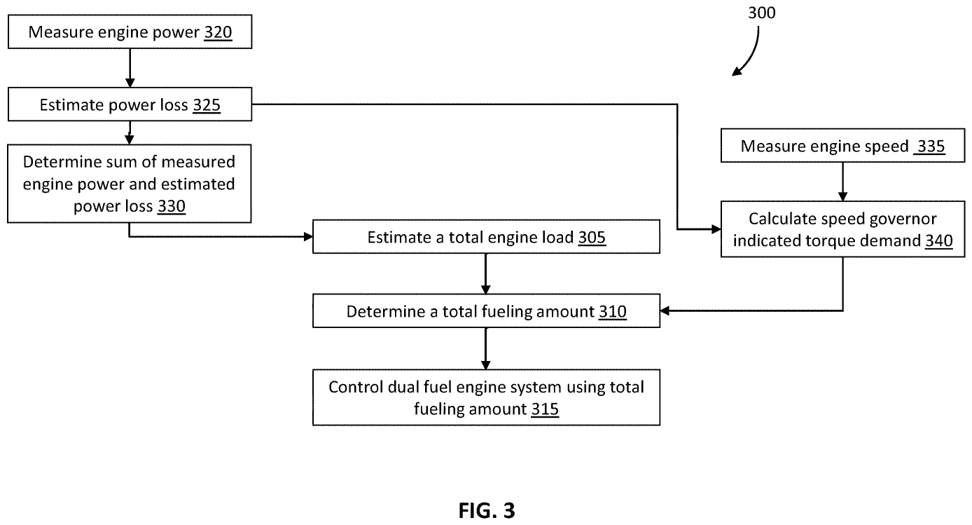

In various implementations, the engine control system 11, which includes the OEM system 12, the first fuel control system 14, and the second fuel control system 16, can cooperate to control the dual fuel engine system 10. FIG. 3 shows a flow diagram illustrating a method 300 of controlling the dual fuel engine system 10, according to an exemplary embodiment. In an operation 305, the engine control system 11 estimates a total engine load (e.g., power, torque, etc.) of the internal combustion engine 20. In various embodiments, the OEM system 12 calculates the total engine load by determining a first load amount (“primary load”) transferred through the engine (e.g., via a flywheel, frac pump load, etc.) and broadcast the determined first load (e.g., via a datalink) to the first fuel control system 12 and/or the second fuel control system 16. In embodiments where the OEM system 12 controls accessory loads (“secondary load,” e.g., cooling fan loads) within the dual fuel engine system 10, the OEM system 12 can estimate the accessory load, add the accessory load to the first load amount, and then broadcast the sum, which is indicative of the total engine load, (e.g., via the datalink) to the systems 14 and/or 16. The control system 11, in an operation 310, the control system 11 can determine a total fueling amount of the internal combustion engine 20. The control system 11, in an operation 315, can then control the dual fuel engine system 10 using the total fueling amount determined in the operation 310.

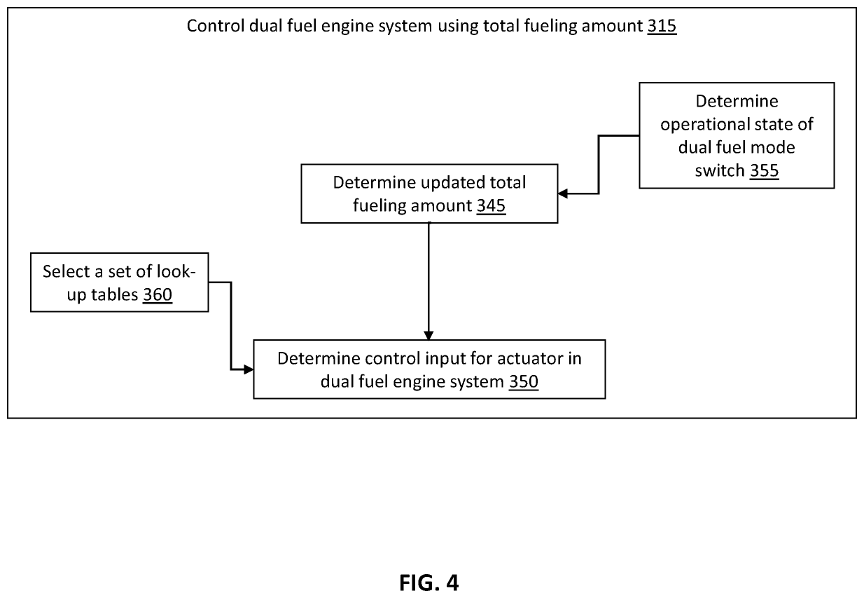

In various implementations, the control system 11 can estimate the total engine load (e.g., power, torque, etc.). In some implementations, the control system 11 estimates the total engine load in the operation 305 by measuring an engine power in an operation 320, estimating a power loss in an operation 325, and determining a sum of the measured engine power and estimated power loss in an operation 330. In some embodiments, the estimated total engine load can be based on an input received from the OEM system 12 (e.g., from one or more sensors, which may sense at least one of a pump discharge pressure, speed, current, or voltage) responsive to or indicative of an external load. The OEM system 12 may then use the input (i.e., the sensed information) to calculate an engine load. The OEM system 12 may then output the calculated load value to the second fuel control system 16 and/or the first fuel control system 14 using a datalink signal and/or an analog signal (e.g., 4-20 mA). In some embodiments, the external load corresponds to at least one of a generator or a pump operably coupled to the internal engine 20. In various implementations, the engine control system 11 can determine the total fueling amount in an operation 310. In some implementations, the control system 11 determines the total fueling amount in the operation 310 based, at least in part, on a measured engine speed 335 and a calculated speed governor indicated torque demand 340. As shown in FIG. 4, in various implementations, controlling the dual fuel engine system 10 in operation 315 can include determining an updated total fueling amount in an operation 345 and determining at least one control input for the at least one actuator 33 in an operation 350. In various embodiments, the at least one actuator 33 can be a first fuel system actuator. In various implementations, the updated total fueling amount determined in operation 345 can be based on determining an operational state of the dual fuel mode switch 55 in an operation 355. In various embodiments, the updated fueling amount determined in the operation 345 includes a first updated fueling amount and a second updated fueling amount. In some embodiments, the first updated fueling amount corresponds to a maximum between the total fueling amount and a fuel command for the first fuel (e.g., diesel, first gas, or other liquid). In some embodiments, the second updated total fueling amount is determined by subtracting the fuel command for the first fuel from the first total updated fueling amount to determine a first fuel equivalent of a second fuel fueling amount and adding the first fuel equivalent fueling amount to a second fuel command for the first fuel.

In various implementations, determining the control input for the at least one actuator 33 (in the operation 350) can be based on selecting a set of look-up tables. The information in the look-up tables can then be referenced in determining the control input. The look-up tables can contain information from one or more of the first fuel ECM and torque fueling calculations module 45, the first fuel air handling, aftertreatment and fuel system reference determination and control module 60, and/or the indicated engine power and second fuel power estimation module 115. The selection of the set of look-up tables can be performed in an operation 360. In various embodiments, selecting the set of look-up tables in the operation 360 includes determining a compressor inlet density (CID) of the internal combustion engine 20. In some embodiments, selecting the set of look-up tables in the operation 360 additionally or alternatively includes determining a G/D within the internal combustion engine 20. In other embodiments, selecting the set of look-up tables in the operation 360 additionally or alternatively includes determining an operational state of the dual fuel mode switch 55. In some embodiments, selecting the set of look-up tables in the operation 360 includes selecting at least one of an air handling reference table, an aftertreatment reference table, or a fueling reference table.

In various implementations, the control system 11 can determine a maximum amount between the total fueling amount (from operation 310) and a first fuel command for the first fuel. In various embodiments, the first fuel command for the first fuel is determined from the first fuel control system 14. In some embodiments, the control system 11 can be configured to determine a second updated total fueling amount. In various embodiments, the second updated fueling amount is determined by subtracting the first fuel command for the first fuel from the first updated total fueling amount to determine a first fuel equivalent of a second fuel fueling amount associated with the internal combustion engine and adding the first fuel equivalent of a second fuel fueling amount to a second fuel command for the first fuel to determine the second updated total fueling amount. In various embodiments, the control system 11 can determine at least one actuator command based on the engine speed and at least one of the first updated total fueling amount or the second updated total fueling amount. In some embodiments, the at least one actuator command can be associated with at least one of an actuator within the air handling control system 80, the aftertreatment control system 85, the first fuel control system 90, or the actuator 33.

In various embodiments, determining the total fueling amount in the operation 310 can include referencing one or more torque-to-fuel look-up tables. In various embodiments, the one or more torque-to-fuel look-up tables are determined or referenced from the first fuel ECM and torque fueling calculations module 45. In various embodiments, the look-up tables can be based on engine speed and an indicated first fuel torque input. In some embodiments, the indicated first fuel torque input can be determined by the sensors 35. In various embodiments, the indicated first fuel torque input determined in the operation 310 is based on a sum of a friction power estimate and an engine speed torque demand amount. In some embodiments, the engine speed torque demand amount corresponds to a difference between the engine speed and a predetermined engine speed target. In various embodiments, the control system 11 determines the power loss estimate in the operation 325. In some embodiments, the control system 11 determines the power loss estimate in the operation 325 by estimating a friction torque amount associated with the internal combustion engine 20, estimating an accessory torque amount, determining a charge air pumping torque amount, and determining the engine speed. In various embodiments, the engine speed is determined via the sensors 35, 40, and/or 95. in various embodiments, the charge air pumping torque amount is an estimate of a pumping loss associated with the dual fuel engine system 10, where the pumping loss corresponds to an amount of work done by the engine to ingest air into the engine to facilitate combustion and then expel combustion products into the atmosphere. In some embodiments, the charge air pumping torque can be measured using cylinder pressure data determined during engine development. In various embodiments, data determined during engine development may be used to calibrate a pumping torque virtual sensor (i.e., operably coupled to the OEM system 12, first fuel control system 14, and/or second fuel control system 16) configured to sense the charge air pumping torque amount.

In some implementations, the friction torque estimate can be determined from a look-up table. In various embodiments, the look-up table is determined or referenced from the first fuel ECM and torque fueling calculations module 45. In some embodiments, the look-up table is based on the engine speed and an engine friction parameter. In some embodiments, the engine friction parameter can correspond to an oil temperature or a coolant temperature within the internal combustion engine 20 of the dual fuel engine system 10. In various embodiments, the control system 11 can be configured to determine the accessory toque estimate from a look-up table. In various embodiments, the look-up table is determined or referenced from the first fuel ECM and torque fueling calculations module 45. In some embodiments, the look-up table is based on the engine speed and an accessory torque parameter. In various embodiments, the accessory torque parameter can correspond to a cooling fan power amount (e.g., a measurement or estimate) or a duty cycle commanded by the internal combustion engine 20 of the dual fuel engine system 10.

In various embodiments, the control system 11 is configured to determine the first fuel command for the first fuel from a torque-to-fuel look-up table. In various embodiments, the torque-to-fuel look-up table is determined or referenced from the first fuel ECM and torque fueling calculations module 45. In some embodiments, the torque-to-fuel look-up table is based on the engine speed (i.e., of the internal combustion engine 20) and a sum of a friction power estimate and a torque demand amount associated with the internal combustion engine 20. In various implementations, the torque demand amount is set by the engine speed governor 50.

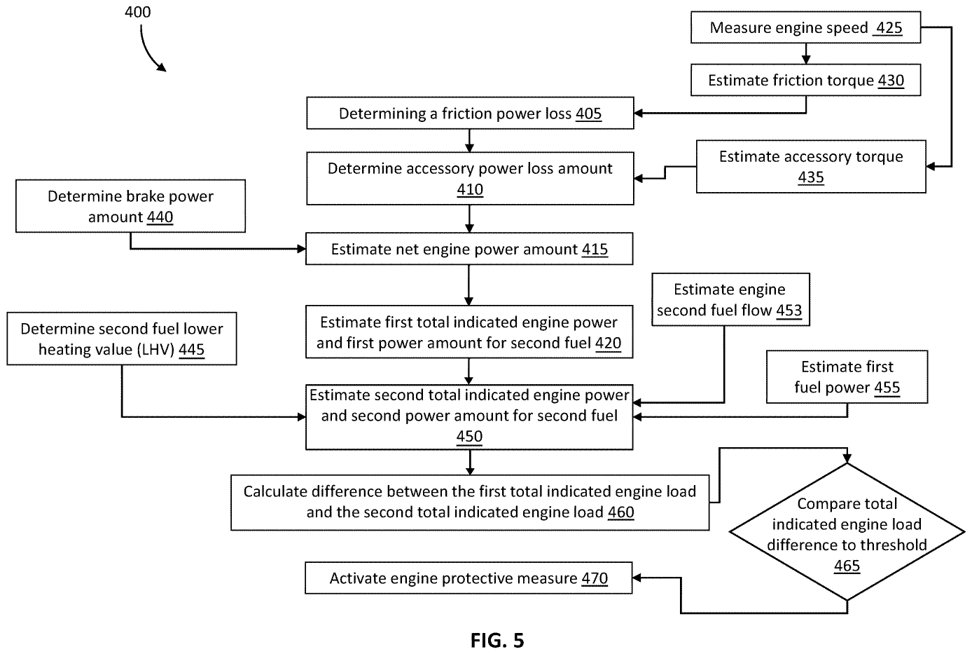

In various embodiments, the control system 11 can be configured to activate one or more protective measures associated with the internal combustion engine 20. In some embodiments, the control system 11 is configured to activate the one or more protective measures via the power rationality diagnostics and protections module 190. FIG. 5 shows a method 400 that can be implemented by the control system 11 to activate one or more engine protective measures. In an operation 405, the control system 11 is configured to determine a friction power loss amount. In various implementations, the friction power loss amount can be determined by measuring a speed of the internal combustion engine 20 in an operation 425 and estimating a friction torque amount in an operation 430. After determining the friction power loss amount in the operation 405, the control system 11 can determine an accessory power loss amount in an operation 410. In various embodiments, the accessory power loss amount can be associated with loads applied by the OEM system 12 (e.g., cooling fans, pumps, alternators, etc.) and/or any other accessory component within or coupled to the internal combustion engine 20.

In various embodiments, the accessory power loss amount can be based on the measured engine speed (determined in the operation 425) and based on an estimated accessory torque amount determined in an operation 435. Using the accessory power loss amount and the friction power loss amount, the control system 11 can estimate a net engine power amount in an operation 415. In various embodiments, the net engine power amount can also be based on a brake power amount (e.g., engine dynamometer measurements) determined by the control system 11 in an operation 440. Using the estimated net engine power amount determined in the operation 415, the control system 11 can estimate a first indicated engine power and a first power amount for the first fuel in an operation 420. In various embodiments, the control system 11 can also estimate an indicated first fuel power. In some embodiments, the control system 11 is configured to estimate the indicated first fuel power by multiplying a determined thermal efficiency correction amount by a determined first fuel power estimate.

In some embodiments, determining the first fuel power estimate includes using a first look-up table. In various embodiments, the first look-up table is determined or referenced from the first fuel ECM and torque fueling calculations module 45. In some embodiments, the first look-up table is based on a first fuel rate and the engine speed. In various embodiments, determining the thermal efficiency correction amount includes referencing a first set of look-up tables. In some embodiments, the first set of look-up tables is determined or referenced from the first fuel ECM and torque fueling calculations module 45. In various embodiments, the first set of look-up table is based on a G/D of the internal combustion engine 20, a KPI associated with the internal combustion engine 20, and/or an intake manifold temperature within the internal combustion engine 20. In various embodiments, estimating the first power amount for the second fuel includes subtracting the indicated first fuel power from the indicated engine power.

The control system 11 can then estimate a second indicated engine power and a second power amount for the second fuel in an operation 450. In various embodiments, the second total indicated engine power and the second power amount of the second fuel can be based, at least in part, on a second fuel LHV value determined in an operation 445. In various embodiments, the LHV determined in the operation 45 can be based on the first power amount of the second fuel (determined in the operation 420), a total second fuel flow estimate, and the thermal efficiency correction amount. In some implementations, the LHV can be determined by an estimate. In various embodiments, the control system 11 can determine the LHV estimate by dividing the first power amount of the second fuel by a multiple of the second fuel flow estimate and the thermal efficiency correction amount. In various implementations, the resultant LHV is an instantaneous LHV amount. In some embodiments, the control system 11 can be configured to implement a learning algorithm to determine the LHV estimate from the instantaneous LHV amount.

In other embodiments, the second total indicated engine power and the second power amount of the second fuel can be based additionally or alternatively on an estimated engine second fuel flow amount (determined in an operation 453) and an estimated first fuel power amount (determined in an operation 455). In various embodiments, determining the second total indicated engine power includes determining a product of the total second fuel flow estimate and the LHV estimate, and summing the product of the total second fuel flow estimate and the LHV estimate with the first fuel power estimate. In some embodiments, the control system 11 can be configured to determine a first power estimate for the second fuel based on the first total indicated engine power and determine a second power estimate for the second fuel based on the LHV estimate and a product of a thermal efficiency parameter and the estimated engine second fuel flow amount. In various embodiments, the thermal efficiency parameter corresponds to the thermal efficiency correction amount. The control system 11 can then determine a final second fuel power estimate based on the first and second power estimates for the second fuel. In various embodiments, the control system 11 can be configured to estimate a G/D of the internal combustion engine 20. In various embodiments, the control system 11 is configured to estimate the G/D of the internal combustion engine 20 by dividing the final second fuel power estimate by the first total engine power estimate.

As shown in FIG. 5, the control system 11 can then calculate a difference between the first total indicated engine load (e.g., power, torque, etc.) (determined in the operation 420) and the second total indicated engine load (e.g., power, torque, etc.) (determined in the operation 450) in an operation 460. The control system 11 can then compare the difference between the first and second total indicated engine loads (calculated in the operation 460) to a predetermined threshold in an operation 465. For example, in various implementations, the control system 11 can determine a difference between the predetermined threshold and the difference between the first and second total indicated engine loads (i.e., total indicated engine load delta). In various embodiments, the predetermined threshold can be set by the OEM and/or a user of the dual fuel engine system 10.

Accordingly, if the difference between the total indicated engine load delta and the predetermined threshold is greater than a predetermined amount, the control system 11 can determine that the dual fuel engine system 10 is operating in an abnormal or adverse condition. In various embodiments, the predetermined threshold is associated with a predetermined period of time. In various embodiments, the predetermined threshold can be set, such as by the controller 18. For example, if the difference between the total indicated engine load delta and the predetermined threshold is greater than the predetermined amount for a predetermined period of time, the control system 11 can determine that the dual fuel engine system 10 is operating in an abnormal or adverse state. Accordingly, responsive to the control system 11 determining that the difference between the first and second total indicated engine loads satisfying the predetermined threshold (or that the total indicated engine load delta exceeds the predetermined amount), the control system 11 can activate one or more engine protective measures 470. For example, the control system 11 can disable dual fuel operation, perform a shut down, and/or cause a reduction in engine speed, etc.

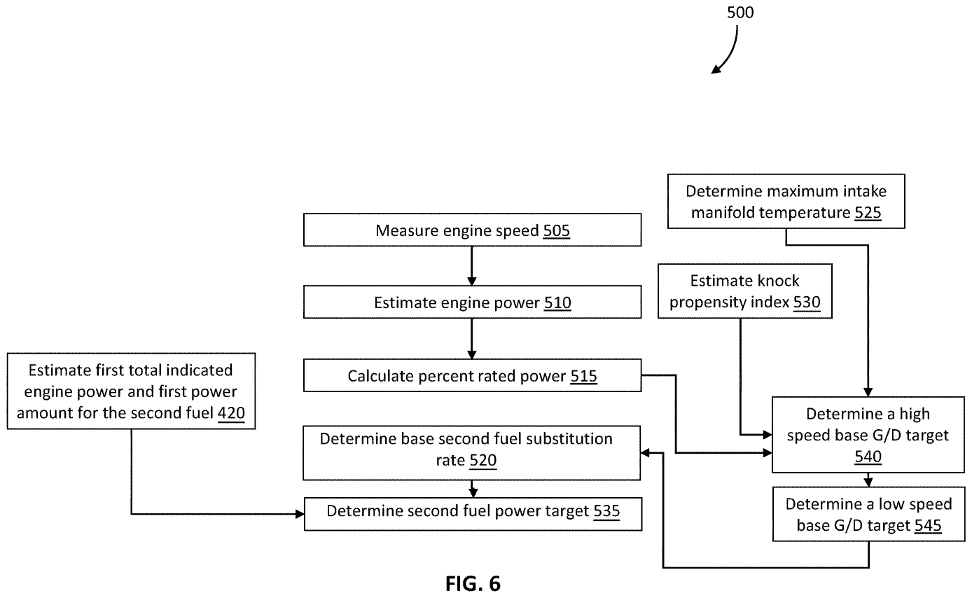

In other embodiments, the control system 11 can be configured to determine one or more second fuel power targets associated with the internal combustion engine 20. FIG. 6 shows a method 500 of determining a second fuel power target associated with the internal combustion engine 20. In an operation 505, the control system 11 measures the engine speed and estimates an engine power amount in an operation 510. In various embodiments, the engine speed is sensed by the sensor 95, 35, and/or 40. In some embodiments, the engine power amount is a net engine power amount. The control system 11 can calculate a percent of rated power (“percent power”) of the internal combustion engine 20 in an operation 515 based on the estimated engine power from operation 510. The percent rated power may be calculated by dividing the net engine power by a rated engine power limit and multiplying by 100%. The control unit can also determine an intake manifold temperature (e.g., maximum intake manifold temperature) in an operation 525 and an estimate of the KPI of the second fuel in an operation 530. The control system 11 can determine a base second fuel substitution rate (G/D) target for the internal combustion engine 20 in an operation 520. In various embodiments, the control system 11 determines the base G/D target based on the engine speed, the percent rated power, the intake manifold temperature (determined in the operation 525), and the estimated KPI of the internal combustion engine 20. The control system 11 then determines a second fuel power target for the internal combustion engine 20 in an operation 535 based on the base second fuel substitution rate target determined in the operation 520. In various embodiments, the second fuel power target is based on the base G/D target and a first indicated engine power estimate. In some embodiments, the control system 11 determines the first indicated engine power estimate by carrying out the operation 420 of the method 400. In various embodiments, the control system 11 is configured to determine (e.g., calculate) the first indicated engine power based on the estimated engine power amount and a friction power loss amount.

In various embodiments, the base G/D target determined in the operation 520 is based on a first speed base G/D target when the engine speed is above a threshold, which can be determined in an operation 540, and a speed base G/D target when the engine speed is below the threshold, which can be determined in an operation 545. In various embodiments, at least one of the first speed base G/D target or the second speed base G/D target are determined based on the intake manifold temperature (determined in the operation 525) and/or the estimated KPI, such as a methane number (determined in the operation 530). In various embodiments, the first speed base G/D target is a high speed base G/D target and the second speed base G/D target is a low speed base G/D target (i.e., lower than the first base G/D target). In some embodiments, the high speed base G/D target is based on the percent rated power, the intake manifold temperature, and the KPI estimate. Similarly, the low speed base G/D target is based on the percent rated power, the intake temperature, and the KPI estimate. Accordingly, the base G/D target determined in the operation 520 is further determined by engine-speed based interpolation between the high speed base G/D target and the low speed base G/D target. In various embodiments, the high speed base G/D target is determined from a first set of look-up tables and the low speed base G/D target is determined from a second set of look-up tables (i.e., from the look-up tables/database 145).

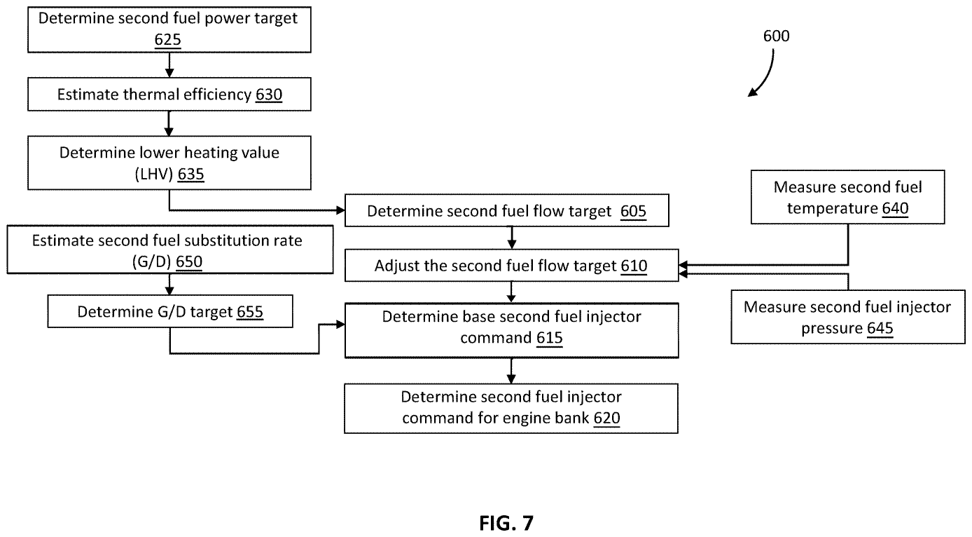

In various embodiments, the control system 11 can be configured to operate the dual fuel engine system 10 in order to determine one or more second fuel injector commands for at least one engine bank within the internal combustion engine 20. FIG. 7 illustrates a method 600 for determining at least one second fuel injector command for at least one engine bank within the internal combustion engine 20. In an operation 605, the control system 11 is configured to determine a second fuel flow target. In various implementations, the second fuel flow target is based on a second fuel power target determined in an operation 625, a thermal efficiency estimate determined in an operation 630, and an LHV determined in an operation 635. In some implementations, the second fuel power target determined in the operation 625 is determined by the control system 11 via the method 500. In other implementations, the LHV determined in the operation 635 is determined via the control system 11 carrying out one or more operations similar or equivalent to the operation 445. In other embodiments, the LHV determined in the operation 635 is determined via an LHV sensor or a look-up table based on the measured or estimated KPI. In various embodiments, determining the second fuel flow target in the operation 605 includes dividing the second fuel power target by the thermal efficiency estimate and the LHV.

The control system 11 is configured to adjust the second fuel flow target in an operation 610 based on at least one of a measured second fuel temperature determined in an operation 640 and/or a measured second fuel injector pressure in an operation 645. In various embodiments, at least one of the second fuel temperature or the second fuel injector pressure is measured by the sensors 35, 40, and/or 95. Using the adjusted second fuel flow target determined in the operation 610, the control system 11 is configured to determine at least one base second fuel injector command in an operation 615. In various embodiments, the at least one base second fuel injector command is further determined based on an estimated G/D of the internal combustion engine 20 determined in an operation 650, and a G/D target determined in an operation 655. In various implementations, the G/D target determined in the operation 655 is determined by the control system 11 by implementing one or more operations similar or equivalent to the operation 520. The control system 11 can then determine at least one second fuel injector command for at least one engine bank of the internal combustion engine 20 in an operation 620. In some embodiments, the second fuel power target is based on a first indicated engine power estimate and the G/D target. In various implementations, the first indicated engine power estimate is determined by the control system 11 by carrying out the operation 420. In some implementations, adjusting the second fuel flow target in the operation 610 includes calculating an adjusted second fuel flow target amount. In various embodiments, the second fuel flow target amount is based on a product of the second fuel flow target and at least one of the following: a first ratio of the measured second fuel temperature and a temperature reference amount, or a second ratio of the measured second fuel injector pressure and a pressure reference amount.

In various implementations, the control system 11 can be further configured to estimate a total second fuel flow amount. In various embodiments, the estimated total second fuel flow amount is based on the measured second fuel injector pressure (determined in the operation 645), the measured second fuel temperature (determined in the operation 640), and the at least one second fuel injector command for the at least one engine bank. In some implementations, the at least one second fuel injector command for the at least one engine bank includes a left bank second fuel injector command (i.e., for the left bank 30) and a right bank second fuel injector command (i.e., for the right bank 31). In other implementations, determining the left bank second fuel injector command and determining the right bank second fuel injector command includes biasing the at least one second fuel injector command for the at least one engine bank to each of the left bank 30 and the right bank 31. In various embodiments, biasing the at least one second fuel injector command for the at least one engine bank to each of the left and right banks 30, 31 is based on an exhaust temperature difference associated with each of the left bank 30 and the right bank 31. In some embodiments, the exhaust temperature difference is measured by the sensors 35, 40, and/or 95. In other embodiments, the exhaust temperature difference corresponds to a difference in an exhaust temperature measured at the left bank 30 and an exhaust temperature measured at the right bank 31. Accordingly, during operation of the dual engine system 10, the control system 11 can measure the exhaust temperature of the left bank 30, measure the exhaust temperature of the right bank 31, and determine a difference between the exhaust temperature of the left bank 30 and the exhaust temperature of the right bank 31. The control system 11 can then add a left bank adjustment amount to the at least one second fuel injector command for the at least one engine bank. In various embodiments, the control system 11 adds the left bank adjustment amount to the at least one second fuel injector command to determine a first adjusted base second fuel injector command based on the difference between the left and right bank exhaust temperatures. Similarly, the control system 11 can then add a right bank adjustment amount to the at least one second fuel injector command for the at least one engine bank. In various embodiments, the control system 11 adds the right bank adjustment amount to the at least one injector command for the second fuel to determine a second adjusted base second fuel injector command based on the difference between the left and right bank exhaust temperatures. The control system 11 can then convert each of the first adjusted base second fuel injector command and the second adjusted base second fuel injector command respectively to the left bank second fuel injector command the right bank second fuel injector command.

In some implementations, determining the at least one second fuel injector command for the at least one engine bank in the operation 615 includes determining a feedforward input for a G/D PID controller, which is operably coupled to the internal combustion engine 20. In various embodiments, the G/D PID controller is the controller 150. In some embodiments, the feedforward input is based on a look-up table. In various embodiments, the look-up table is determined or referenced from the first fuel ECM and torque fueling calculations module 45, the first fuel air handling, aftertreatment & fuel system reference determination & control module 60, and/or the indicated engine power & second fuel power estimation module 115.

In various embodiments, the look-up table is based on at least one of the measured second fuel injector pressure, the measured second fuel temperature, or the adjusted second fuel flow target amount. In some embodiments, the control system 11 is further configured to determine at least one heat control valve command. In various embodiments, the at least one heat control valve command is associated with the heater control valve 195. In some embodiments, the at least one heat control valve command is based on the measured second fuel temperature and/or a measured second fuel mass flow within the internal combustion engine 20. In yet other embodiments, the control system 11 is further configured to adjust at least one second fuel temperature setpoint based on the measured KPI and/or the estimated KPI number. In various embodiments, the measured KPI is measured by the sensors 35, 40, and/or 95. In some embodiments, the estimated KPI number is determined by the KPI estimation module 125. In some implementations, the at least one second fuel temperature setpoint is based on an engine protection setpoint. In various embodiments, the engine protection setpoint is determined or set by the OEM system 12, the first fuel control system 14, or the second fuel control system 16.

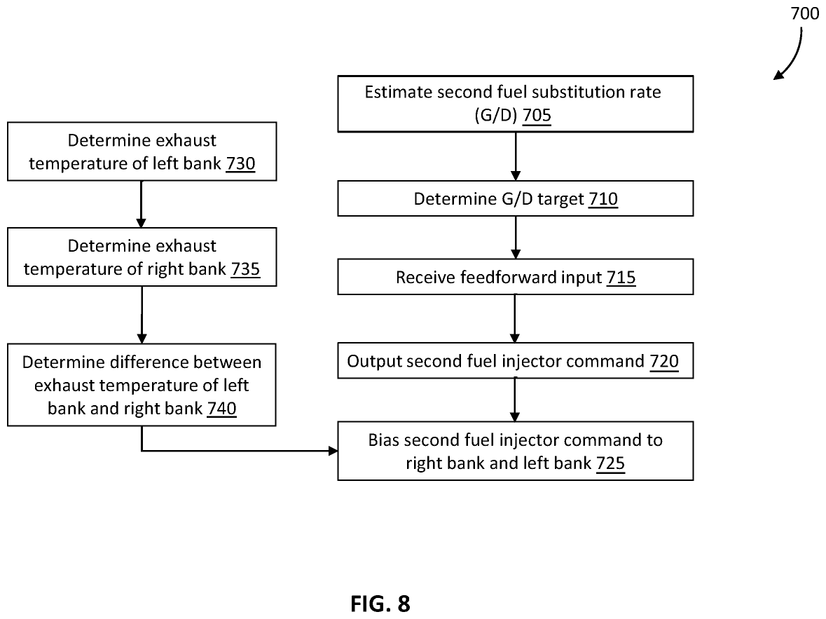

FIG. 8 shows a method 700 carried out by the dual fuel engine system 10. In various embodiments, the dual fuel engine system 10 includes at least one PID controller coupled to the internal combustion engine 20 and the second fuel injector 28. In an operation 705, the control system 11 determines a G/D estimate. In various embodiments, the G/D estimate is determined from the LHV and G/D estimation module 120. The control system 11 then determines a G/D target in an operation 710. In various embodiments, the control system 11 determines the G/D target in the operation 710 by carrying out one or more operations similar or equivalent to the operation 520 in the method 500. In an operation 715, the at least one PID controller is configured to receive a feedforward input in addition to the G/D estimate and the G/D target. In various embodiments, the feedforward input is based on a look-up table, which can be determined or referenced from the first fuel ECM and torque fueling calculations module 45, the first fuel air handling, aftertreatment & fuel system reference determination & control module 60, and/or the indicated engine power & second fuel power estimation module 115. In some embodiments, the G/D target is determined from the LHV and G/D estimation module 120. In an operation 720, the at least one PID controller is configured to output at least one second fuel injector command. In an operation 725, the at least one PID controller then biases the at least one second fuel injector command to each of the left bank 30 and the right bank 31. In various embodiments, the at least one PID controller biases the at least one second fuel injector command to each of the left bank 30 and the right bank 31 based on the difference between each of the left bank exhaust temperature (determined in the operation 730) and the right bank exhaust temperature (determined in the operation 735). In various embodiments, the exhaust temperature difference is determined in an operation 740. In some embodiments, the at least one PID controller includes a first PID controller and a second PID controller. For example, the first PID controller can be configured to receive the feedforward input, the G/D estimate, and the G/D target (i.e., the PID controller 150), and the second PID controller can be configured to bias the at least one second fuel injector command to each of the left bank 30 and the right bank 31 (i.e., the bank balancing PID 155).

In some embodiments, the dual fuel engine system 10 includes an aftertreatment system (i.e., controlled by the aftertreatment control system 85) operably coupled to the internal combustion engine 20, a second fuel injection system that includes the at least one second fuel injector 28 (i.e., controlled by the second fuel injector control module 110), and an air handling system (i.e., controlled by the air handling control system 80) operably coupled to the internal combustion engine 20. In some embodiments, the aftertreatment system is a selective catalytic reduction (SCR) and oxidation catalysts (OC) system. In some embodiments, the second fuel injection system is configured to independently control second fuel injection (i.e., via the at least one second fuel injector 28) on each of the left bank 30 and the right bank 31. In other embodiments, the air handling system is configured to control air flow through the internal combustion engine 20. In some embodiments, the air handling system controls the air flow independently from an operating condition of the internal combustion engine 20. In other embodiments, the air flow is based on a predetermined value obtained from a look-up table. In various embodiments, the look-up table is determined from or corresponds to the database 75 in the module 60). In various embodiments, the predetermined value is associated with a target temperature in at least one location of the aftertreatment system.

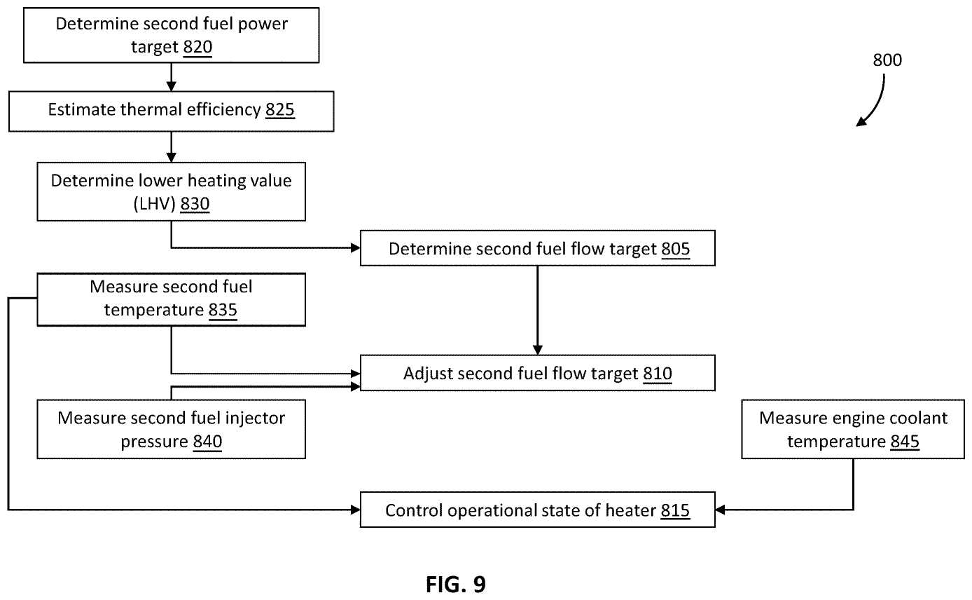

In various embodiments, the dual fuel engine system 10 includes one or more heaters operably coupled to the at least one second fuel injector 28 and the internal combustion engine 20. The at least one heater is configured to adjust a temperature of (i.e., heat) the second fuel flowing within the internal combustion engine 20. FIG. 9 illustrates a method 800 for controlling an operational state of the heater, which is coupled to the internal combustion engine 20. In an operation 805, the control system 11 is configured to determine a second fuel flow target. For example, the control system 11 is configured to determine a second fuel flow target, via one or more operations that are similar or equivalent to the operation 605. In various implementations, the second fuel flow target determined in the operation 805 can be based on one or more of a second fuel power target, an estimated thermal efficiency, and an LHV. For example, the second fuel flow target can be based on a second fuel power target determined in an operation 820, an estimated thermal efficiency of the internal combustion engine 20 determined in an operation 825, and an LHV determined in an operation 830. The control system 11 can adjust the second fuel flow target in an operation 810 based on at least one of a measured second fuel temperature or a measured second fuel injector pressure. For example, the control system 11 is configured to adjust the second fuel flow target in an operation 810 based on at least one of a measured second fuel temperature determined in an operation 835 or a measured second fuel injector pressure determined in an operation 840. In various implementations, the measured second fuel temperature determined in the operation 835 is determined by the control system 11 by carrying out one or more operations similar or equivalent to the operation 640. In some embodiments, the measured second fuel temperature is determined via the sensors 35, 40, and/or 95. In various embodiments, the measured second fuel injector pressure determined in the operation 840 is determined by the control system 11 by carrying out one or more operations similar or equivalent to the operation 645. In some embodiments, the measured second fuel injector pressure is determined via the sensors 35, 40, and/95. The control system 11 can then control an operational state of the heater 32 based on at least one of the measured second fuel temperature or a measured engine coolant temperature. In some embodiments, at least one of the measured second fuel temperature or the measured engine coolant temperature is determined via the sensors 35, 40, and/or 95.

In some embodiments, the control system 11 is configured to perform an on/off control of the heater 32 responsive to a determination made regarding the measured second fuel temperature relative to one or more threshold temperatures. For example, the control system 11 is configured to control operation of the heater 32 in response to a determination that the measured second fuel temperature is less than a first threshold temperature for a first period. In particular, in some embodiments, the control system 11 is configured to operate the heater 32 (i.e., to turn on) in response to a determination that the measured second fuel temperature (determined in the operation 835) is less than a first threshold temperature for a first period. In various embodiments, the first threshold temperature is set by the OEM system 12, the first fuel control system 14, or the second fuel control system 16. In other embodiments, the control system 11 is configured to control operation of the heater 32 in response to a determination that the measured second fuel temperature is greater than a second threshold temperature for a second period. For example, the control system 11 is configured to operate the heater 32 (i.e., to turn off) in response to a determination that the measured second fuel temperature (determined in the operation 835) is greater than a second threshold temperature for a second period. In various embodiments, the second threshold temperature is set by the OEM system 12, the first fuel control system 14, or the second fuel control system 16.

Notwithstanding the embodiments described above in reference to FIGS. 1-9, various modifications and inclusions to those embodiments are contemplated and considered within the scope of the present disclosure.

The present technology may also include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A method for controlling a dual fuel engine system, the method comprising:
   estimating a total indicated engine load, the total indicated engine load being based on a sum of a measured engine power and a power loss estimate; and
   determining a total fueling amount based on an engine speed and the total indicated engine load, the total fueling amount including a first fuel fueling amount and a second fuel fueling amount; and
   controlling the dual fuel engine system using the total fueling amount.
B. The method of paragraph A, wherein the method further includes determining a first updated total fueling amount based on a maximum between the total fueling amount and a first fuel command for the first fuel.
C. The method of paragraph B, wherein the method further includes determining a second updated total fueling amount, and wherein determining the second updated total fueling amount includes: subtracting the first fuel command for the first fuel from the first updated total fueling amount to determine a first fuel equivalent of a second fueling amount; and adding the first fuel equivalent of a second fueling amount to a second fuel command for the first fuel.
D. The method of paragraph A, wherein controlling the dual fuel engine system includes determining a first fuel system actuator command.
E. The method of paragraph A, wherein determining the total fueling amount includes referencing a torque to fuel look-up table, the torque to fuel look-up table being based on the engine speed and an indicated first fuel torque input.
F. The method of paragraph A, wherein the method further includes determining the power loss estimate based on a friction torque estimate, an accessory torque estimate, a charge air pumping torque, and the engine speed.
G. The method of paragraph F, wherein the method further includes:
   determining the friction torque estimate from a second look-up table, the second look-up table being based on the engine speed and an engine friction parameter;
   wherein the engine friction parameter is based on at least one of an oil temperature or a coolant temperature within the dual fuel engine system.
H. The method of paragraph E, wherein the method further includes determining the accessory torque estimate from a third look-up table, the third look-up table being based on the engine speed and an accessory torque parameter.
I. The method of paragraph H, wherein the method further includes determining the accessory torque parameter based on a cooling fan power or duty cycle commanded by the dual fuel engine system.
J. The method of paragraph B, wherein the method further includes determining at least one actuator command based on the engine speed and at least one of the first updated total fueling amount or the second updated total fueling amount.
K. The method of paragraph A, wherein the method further includes determining the first fuel command for the first fuel from a torque to fuel look-up table, the torque to fuel look-up table being based on the engine speed and a sum of a friction power estimate and a torque demand amount, the torque demand amount being set by an engine speed governor within the dual fuel engine system.
L. A method for controlling a dual fuel engine system, the method comprising:
   estimating a total indicated engine load, the total indicated engine load being based on a sum of a measured engine power, a friction power estimate, and an accessory power estimate;
   determining a total fueling amount from a first look-up table, the look-up table based on an engine speed and the total indicated engine load;
   determining at least one updated total fueling amount based on the total fueling amount and an operational state of a dual fuel mode switch within the dual fuel engine system; and
   determining a control input for at least one actuator within the dual fuel engine system;
   wherein the control input is based on selecting a corresponding set of look-up tables associated with the at least one actuator, the look-up table set comprising a plurality of look-up tables, each of the plurality of look-up tables being based on the engine speed and the at least one updated total fueling amount.
M. The method of paragraph L, wherein the at least one actuator is at least one of an air handling actuator, an aftertreatment actuator, or a first fuel system actuator.
N. The method of paragraph L, wherein selecting the corresponding set of look-up tables includes determining a compressor inlet density, a second fuel substitution rate within the dual engine system, and the operational state of the dual fuel mode switch.
O. The method of paragraph N, wherein selecting the look-up table set further includes selecting at least one of an air handling reference table, an aftertreatment reference table, or a fueling reference table.
P. The method of paragraph O, wherein the at least one updated fueling amount includes a first updated fueling amount and a second updated fueling amount, wherein the first updated fueling amount corresponds to a maximum between the total fueling amount and a fuel command for a first fuel, and wherein the second updated fueling amount is determined by subtracting the fuel command for the first fuel from the first updated total fueling amount to determine a first fuel equivalent of a second fuel fueling amount and adding the first fuel equivalent fueling amount to a second fuel command for the first fuel.
Q. A dual fuel engine system comprising:
   an internal combustion engine operable in a dual fueling mode;
   at least one actuator operably coupled to the internal combustion engine; and
   at least one controller in communication with the internal combustion engine and the at least one actuator;
   wherein the at least one controller is configured to:
      receive a first input corresponding to an engine speed and a second input corresponding to a measured engine power;
      calculate a power loss estimate;
      determine a total fueling amount based on the measured engine power and a power loss estimate;
      determine a first fuel command for a first fuel associated with the internal combustion engine based on at least a calculated speed governor command and the power loss estimate;
      determine at least one updated total fueling amount based on the total fueling amount and the first fuel command for the first fuel;
      select a look-up table set associated with the at least one actuator based on a second fuel substitution rate associated with the internal combustion engine, the look-up table set being based on the engine speed and the at least one updated total fueling amount; and
      send an input to the at least one actuator based on the look-up table set.
R. The system of paragraph Q, wherein the at least one controller is further configured to determine the indicated first fuel torque input based on a sum of the friction power estimate and an engine speed torque demand amount, the engine speed torque demand amount corresponding to a difference between the engine speed and an engine speed target.
S. The system of paragraph Q, wherein the at least one controller is configured to determine the power loss estimate based on a friction torque estimate, an accessory torque estimate, a charge air pumping torque, and the engine speed.
T. The system of paragraph Q, wherein the at least one controller is further configured to select the look-up table based on a compressor inlet density.
U. A method for controlling a dual fuel engine system configured to operate using a first fuel and a second fuel, the method comprising:
   determining a friction power loss amount of an internal combustion engine of the dual fuel engine system, the friction power loss amount being based on an engine speed of the internal combustion engine and a friction torque estimate;
   determining an accessory power loss amount of a power of the internal combustion engine, the accessory power loss amount being based on the engine speed and an accessory torque estimate;
   estimating a net engine power amount based on the accessory power loss amount and a brake power amount of the internal combustion engine;
   estimating an indicated power for the first fuel; and
   estimating, based on the estimated net engine power, a first indicated engine power and a first power for the second fuel.
V. The method of paragraph U, wherein estimating the indicated power for the first fuel comprises multiplying a determined thermal efficiency correction amount by a determined power estimate for the first fuel.
W. The method of paragraph V, wherein determining the power estimate for the first fuel comprises using a first look-up table, the first look-up table being based on a fuel rate for the first fuel and the engine speed.
X. The method of paragraph V, wherein determining the thermal efficiency correction amount comprises consulting a first set of look-up tables, the first set of look-up tables being based on at least one of a substitution rate for the second fuel, a knock propensity index, or an intake manifold temperature.
Y. The method of paragraph V, further comprising determining a lower heating value (LHV) estimate for the second fuel based on the first power for the second fuel, a total second fuel flow estimate, and the thermal efficiency correction amount.
Z. The method of paragraph Y, wherein determining the LHV estimate comprises:
   dividing the first power for the second fuel by a multiple of the second fuel flow estimate and the thermal efficiency correction amount to determine an instantaneous LHV amount.
AA. The method of paragraph Z, further comprising applying a learning algorithm to the instantaneous LHV amount to determine the LHV estimate.
BB. The method of paragraph Y, further comprising estimating a second total indicated engine power, wherein estimating the second total indicated engine power comprises:
   determining a product of the total flow estimate for the second fuel and the LHV estimate; and
   determining a sum of the power estimate for the first fuel and the product of the total second fuel flow and the LHV estimate.
CC. The method of paragraph BB, further comprising determining a difference between the first total indicated engine power and the second total indicated engine power.
DD. The method of paragraph CC, further comprising activating at least one engine protective measure based on the difference between the first total indicated engine power and the second total indicated engine power being greater than a threshold.
EE. The method of paragraph DD, further comprising setting the threshold to correspond to a predetermined period.
FF. The method of paragraph V, wherein estimating the first power for the second fuel comprises subtracting the indicated power for the first fuel from the indicated engine power.
GG. A method for controlling a dual fuel engine system configured to operate using a first fuel and a second fuel, the method comprising:
   estimating a net engine power amount of an internal combustion engine of the dual fuel engine system based on an accessory power loss amount of a power of the internal combustion engine, and a brake power estimate of the internal combustion engine;
   determining a first total indicated engine power based on the net engine power and a friction power loss amount of the internal combustion engine;
   determining a lower heating value (LHV) for the second fuel within the internal combustion engine, the LHV being a measured value or an estimated value;
   estimating a second total indicated engine power based on the LHV, a total flow estimate for the second fuel, and a power estimate for the first fuel; and
   activating at least one engine protective measure based on a difference between the first total indicated engine power and the second total indicated engine power being greater than a predetermined threshold.
HH. The method of paragraph GG, wherein estimating the second total indicated engine power comprises:
   determining a sum of the power estimate for the first fuel and a product of the total second fuel flow and the LHV.
II. The method of paragraph GG, further comprising:
   determining a first power estimate for the second fuel, the first power estimate for the second fuel being based on the first total indicated engine power;
   determining a second power estimate for the second fuel, the second power estimate for the second fuel being based on the LHV and a product of a thermal efficiency estimate and the total second fuel flow estimate; and
   determining a final second fuel power estimate based on the first power estimate for the second fuel and the second power estimate for the second fuel.
JJ. The method of paragraph II, further comprising estimating a substitution rate for the second fuel, wherein estimating the substitution rate for the second fuel comprises:
   dividing the final second fuel power estimate by the first power estimate.
KK. A dual fuel engine system operable in a dual fueling mode, comprising:
   At least one controller in communication with an internal combustion engine, the internal combustion engine configured to operate using a first fuel and a second fuel;
   wherein the at least one controller is configured to:
      receive an input corresponding to an engine speed of the internal combustion engine;
      receive an input for calculating a net engine power estimate;
      calculate a percent rated power of the internal combustion engine based on the engine speed and the net engine power estimate;
      determine a base substitution rate target of the second fuel for the internal combustion engine based on the engine speed, the percent rated power, an intake manifold temperature within the internal combustion engine, and a knock propensity index estimate within the internal combustion engine; and
      determine a second fuel power target for the internal combustion engine based on the base substitution rate target of the second fuel and a first indicated engine power estimate.
LL. The system of paragraph KK, wherein the controller is configured to determine the base substitution rate target of the second fuel by carrying out the following operations:
   determining a first speed base substitution rate target of the second fuel when the engine speed is above a threshold based on the percent rated power, the intake manifold temperature, and the knock propensity index estimate;
   determining a second speed base substitution rate target of the second fuel when the engine speed is below the threshold based on the percent rated power, the intake manifold temperature, and the knock propensity index estimate; and
   determine the base substitution rate target of the second fuel based on the engine speed, the high speed base substitution rate target of the second fuel, and the low speed base substitution rate target of the second fuel.
MM. The system of paragraph LL, wherein the first speed base substitution rate target of the second fuel is determined based on a first set of look-up tables and the second speed base substitution rate target of the second fuel is determined based on a second set of look-up tables.
NN. The system of paragraph KK, wherein the controller is configured to determine the first indicated engine power based on the net engine power estimate and a friction power loss amount.
OO. A method for controlling a dual fuel engine system configured to operate using a first fuel and a second fuel, the method comprising:
   determining a flow target of the second fuel for an internal combustion engine of the dual fuel engine system, the flow target of the second fuel being based on a power target of the second fuel of the internal combustion engine, a thermal efficiency estimate of the internal combustion engine, and a lower heating value (LHV) within the internal combustion engine;
   adjusting the flow target of the second fuel based on at least one of a measured second fuel temperature or a measured second fuel injector pressure;
   determining at least one base second fuel injector command based on the adjusted flow target of the second fuel, a second fuel substitution rate estimate, and a second fuel substitution rate target; and
   determining, based on the at least one base second fuel injector command, a second fuel injector command for at least one engine bank.
PP. The method of paragraph OO, further comprising estimating a total second fuel flow based on the measured second fuel injector pressure, the measured second fuel temperature, and the at least one injector command for the second fuel for the at least one engine bank.
QQ. The method of paragraph OO, wherein the at least one engine bank comprises a left bank and a right bank, wherein the at least one injector command for the second fuel for the at least one engine bank comprises a left bank second fuel injector command and a right bank second fuel injector command, and determining the left bank second fuel injector command and the right bank second fuel injector command comprises:
   biasing the at least one injector command for the second fuel for the at least one engine bank to each of an engine right bank and an engine left bank based on an exhaust temperature difference associated with each of the engine right bank and the engine left bank.
RR. The method of paragraph QQ, wherein biasing the at least one base second fuel injector command to each of the engine right bank and an engine left bank comprises:
   measuring a left bank exhaust temperature;
   measuring a right bank exhaust temperature;
   determining a difference between the right bank exhaust temperature and the left bank exhaust temperature;
   adding a left bank adjustment amount to the at least one injector command for the second fuel for the at least one engine bank to determine a first adjusted base second fuel injector command based on the difference between the right bank exhaust temperature and the left bank exhaust temperature;
   adding a right bank adjustment amount to the at least one injector command for the second fuel for the at least one engine bank to determine a second adjusted base second fuel injector command based on the difference between the right bank exhaust temperature and the left bank exhaust temperature; and
   converting each of the first adjusted base second fuel injector command and the second adjusted base second fuel injector command respectively to the left bank second fuel injector command and the right bank second fuel injector command.
SS. The method of paragraph OO, wherein determining the flow target for the second fuel comprises dividing the power target of the second fuel by the thermal efficiency estimate and the LHV.
TT. The method of paragraph SS, wherein the power target of the second fuel is based on a first indicated engine power estimate and the second fuel substitution rate target.
UU. The method of paragraph OO, wherein adjusting the flow target of the second fuel comprises:
   calculating an adjusted second fuel flow target amount, the adjusted second fuel flow target amount being a product of the flow target and at least one of a first ratio of the measured second fuel temperature and a temperature reference amount or a second ratio of a measured pressure and a pressure reference amount.
VV. The method of paragraph UU, wherein determining at least one injector command for the second fuel for the at least one engine bank comprises:
   determining a feedforward input for a second fuel substitution rate proportional-integral-derivative controller operably coupled to the internal combustion engine, the feedforward input being based on a look-up table referencing at least one of the measured second fuel injector pressure, the measured second fuel temperature, or the adjusted second fuel flow target amount.
WW. The method of paragraph VV, further comprising:
   adjusting at least one temperature setpoint for the second fuel based on at least one of a measured knock propensity index or an estimated knock propensity index.
XX. The method of paragraph WW, wherein the at least one temperature setpoint for the second fuel is based on an engine protection setpoint.
YY. A dual fuel engine system for an internal combusting engine configured to operate using a first fuel and a second fuel, the dual fuel engine system comprising:
   at least one injector for the second fuel operably coupled to the internal combustion engine having a left bank and a right bank, the internal combustion engine being operable in a dual fuel mode; and
   at least one proportional-integral-derivative (PID) controller communicably coupled to the internal combustion engine and the at least one injector for the second fuel;
   wherein the at least one PID controller is configured to:
      receive a feedforward input, a second fuel substitution rate estimate, and a second fuel substitution rate target;
      output, based on the feedforward input, at least one injector command for the second fuel; and
      bias the at least one injector command for the second fuel to each of the right bank and the left bank based on an exhaust temperature difference associated with each of the right bank and the left bank.
ZZ. The system of paragraph YY, wherein the at least one PID controller is configured to bias the at least one injector command for the second fuel to each of the right bank and the left bank by carrying out the operations comprising:
   measuring a left bank exhaust temperature;
   measuring a right bank exhaust temperature;
   determining a difference between the right bank exhaust temperature and the left bank exhaust temperature;
   adding a left bank adjustment amount to the at least one injector command for the second fuel to determine a first adjusted injector command for the second fuel;
   adding a right bank adjustment amount to the at least one injector command for the second fuel to determine a second adjusted injector command for the second fuel; and
   converting each of the first adjusted injector command for the second fuel and the second adjusted injector command for the second fuel respectively to the left bank injector command for the second fuel and the right bank injector command for the second fuel.
AAA. The system of paragraph YY, wherein the at least one PID controller comprises a first PID controller and a second PID controller, wherein the first PID controller is configured to receive the feedforward input, the second fuel substitution rate estimate, and the second fuel substitution rate target, and wherein the second PID controller is configured to bias the at least one injector command for the second fuel to each of the right bank and the left bank.
BBB. The system of paragraph YY, further comprising:
   an aftertreatment system operably coupled to the internal combustion engine, the aftertreatment system being a selective catalytic reduction (SCR) and oxidation catalysts (OC) system;
   an injection system for the second fuel operably coupled to the internal combustion engine, the injection system for the second fuel including the at least one injector for the second fuel, wherein the injection system for the second fuel is configured to independently control injection of the second fuel on each of the left bank and the right bank; and
   an air handling system operably coupled to the internal combustion engine, the air handling system configured to control an air flow through the internal combustion engine independent of an operating condition of the internal combustion engine, wherein the air flow is based on a predetermined value obtained from a look-up table, the predetermined value associated with a target temperature in at least one location of the aftertreatment system.
CCC. A dual fuel engine system operable in a dual fuel mode, the dual fuel engine system comprising:
   an internal combustion engine having at least one engine bank, the internal combustion engine configured to operate using a first fuel and a second fuel;
   at least one injector for the second fuel operably coupled to the internal combustion engine; and
   at least one controller communicably coupled to the internal combustion engine and the at least one injector for the second fuel;
   wherein the at least one controller is configured to:
      determine a second fuel flow target for the internal combustion engine, the second fuel flow target being based on a second fuel power target of the internal combustion engine, a thermal efficiency estimate of the internal combustion engine, and a lower heating value (LHV) within the internal combustion engine;
      adjust the second fuel flow target based on at least one of a measured second fuel temperature or a measured second fuel injector pressure to determine an adjusted second fuel flow target for the dual fuel mode;
      determine at least one base second fuel injector command based on the adjusted second fuel flow target, a substitution rate estimate for the second fuel, and a substitution rate target for the second fuel; and
      determine, based on the at least one base second fuel injector command, an injector command for the second fuel for the at least one engine bank.
DDD. The system of paragraph CCC, wherein the at least one controller is further configured to:
   determine, based on the at least one injector command for the second fuel, a left bank second fuel injector command and a right bank second fuel injector command.
EEE. The system of paragraph DDD, wherein the at least one controller is further configured to determine the second fuel flow target by dividing the second fuel power target by a thermal efficiency estimate and a lower heating value (LHV), wherein the LHV is determined on a look-up table based on an estimated knock propensity index

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (e.g., permanent or fixed) or moveable (e.g., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References herein to the positions of elements (e.g., “top,” “bottom,” “above,” “below”) are merely used to describe the orientation of various elements in the FIGURES. It should be noted that the orientation of various elements can differ according to other exemplary embodiments, and that such variations are intended to be encompassed by the present disclosure.

In some embodiments, hardware and data processing components used to implement the various processes, operations, illustrative logics, logical blocks, modules and circuits described in connection with the embodiments disclosed herein, such as hardware and data processing components of controller (e.g., a memory within the controller 18, a memory within the OEM system 12, a memory in the first fuel control system 14, or a memory within the second fuel control system 16), can be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor can be a microprocessor, or, any conventional processor, controller, microcontroller, or state machine. A processor also can be implemented as a combination of computing devices, such as a combination of a DSP and a microprocessor, a plurality of microprocessors, one or more microprocessors in conjunction with a DSP core, or any other such configuration. In some embodiments, particular processes and methods can be performed by circuitry that is specific to a given function. The memory (e.g., memory, memory unit, storage device) can include one or more devices (e.g., RAM, ROM, Flash memory, hard disk storage) for storing data and/or computer code for completing or facilitating the various processes, layers and modules described in the present disclosure. The memory can be or include volatile memory or non-volatile memory, and can include database components, object code components, script components, or any other type of information structure for supporting the various activities and information structures described in the present disclosure. According to an exemplary embodiment, the memory (e.g., a memory within the controller 18, a memory within the OEM system 12, a memory in the first fuel control system 14, or a memory within the second fuel control system 16) is communicably connected to the processor via a processing circuit and includes computer code for executing (e.g., by the processing circuit or the processor) the one or more processes described herein.

The present disclosure contemplates methods and systems on any machine-readable media for accomplishing various operations, e.g., such as operations 305-360 of the method 300, operations 405-470 of the method 400, operations 505-545 of the method 500, operations 605-655 of the method 600, operations 705-740 of the method 700, and operations 805-845 of the method 800. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description can illustrate a specific order of method steps, the order of such steps can differ from what is depicted and described, unless specified differently above. Also, two or more steps can be performed concurrently or with partial concurrence, unless specified differently above.

It is important to note that any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A method for controlling a dual fuel engine system configured to operate using a first fuel and second fuel, the method comprising:
estimating a total indicated engine load, the total indicated engine load being based on a sum of a measured engine power and a power loss estimate;
determining a total fueling amount based on an engine speed and the total indicated engine load, the total fueling amount including a fueling amount for the first fuel and a fueling amount for the second fuel; and
controlling the dual fuel engine system using the total fueling amount.

2. The method of claim 1, further comprising determining a first updated total fueling amount based on a maximum between the total fueling amount and a first fuel command for the first fuel.

3. The method of claim 2, further comprising determining a second updated total fueling amount, wherein determining the second updated total fueling amount comprises:
subtracting the first fuel command for the first fuel from the first updated total fueling amount to determine a first fuel equivalent of a second fuel fueling amount; and
adding the first fuel equivalent of a second fuel fueling amount to a second fuel command for the first fuel.

4. The method of claim 1, wherein controlling the dual fuel engine system comprises determining a fuel system actuator command for the first fuel.

5. The method of claim 1, wherein determining the total fueling amount comprises referencing a torque to fuel look-up table, the torque to fuel look-up table being based on the engine speed and an indicated first fuel torque input.

6. The method of claim 1, further comprising determining the power loss estimate based on a friction torque estimate, an accessory torque estimate, a charge air pumping torque, and the engine speed.

7. The method of claim 6, further comprising:
determining the friction torque estimate from a second look-up table, the second look-up table being based on the engine speed and an engine friction parameter;
wherein the engine friction parameter is based on at least one of an oil temperature or a coolant temperature within the dual fuel engine system.

8. The method of claim 5, further comprising determining the accessory torque estimate from a third look-up table, the third look-up table being based on the engine speed and an accessory torque parameter.

9. The method of claim 8, further comprising determining the accessory torque parameter based on a cooling fan power or duty cycle commanded by the dual fuel engine system.

10. The method of claim 2, further comprising determining at least one actuator command based on the engine speed and at least one of the first updated total fueling amount or the second updated total fueling amount.

11. The method of claim 1, further comprising determining the first fuel command for the first fuel from a torque to fuel look-up table, the torque to fuel look-up table being based on the engine speed and a sum of a friction power estimate and a torque demand amount, the torque demand amount being set by an engine speed governor within the dual fuel engine system.

12. A method for controlling a dual fuel engine system configured to operate using a first fuel and a second fuel, the method comprising:
estimating a total indicated engine load, the total indicated engine load being based on a sum of a measured engine power, a friction power estimate, and an accessory power estimate;
determining a total fueling amount from a first look-up table, the look-up table based on an engine speed and the total indicated engine load;
determining at least one updated total fueling amount based on the total fueling amount and an operational state of a dual fuel mode switch within the dual fuel engine system; and
determining a control input for at least one actuator within the dual fuel engine system;
wherein the control input is based on selecting a corresponding set of look-up tables associated with the at least one actuator, the look-up table set comprising a plurality of look-up tables, each of the plurality of look-up tables being based on the engine speed and the at least one updated total fueling amount.

13. The method of claim 12, wherein the at least one actuator is at least one of an air handling actuator, an aftertreatment actuator, or a fuel system actuator for the first fuel.

14. The method of claim 12, wherein selecting the corresponding set of look-up tables comprises determining a compressor inlet density, a substitution rate for the second fuel within the dual engine system, and the operational state of the dual fuel mode switch.

15. The method of claim 14, wherein selecting the look-up table set further comprises selecting at least one of an air handling reference table, an aftertreatment reference table, or a fueling reference table.

16. The method of claim 15, wherein the at least one updated fueling amount includes a first updated fueling amount and a second updated fueling amount, wherein the first updated fueling amount corresponds to a maximum between the total fueling amount and a fuel command for the first fuel, and wherein the second updated fueling amount is determined by subtracting the fuel command for the first fuel from the first updated total fueling amount to determine a fuel equivalent for the first fuel of a fueling amount for the second fuel and adding the equivalent fueling amount for the first fuel to a second fuel command for the first fuel.

17. A dual fuel engine configured to operate using a first fuel and a second fuel, the engine system comprising:
an internal combustion engine operable in a dual fueling mode;
at least one actuator operably coupled to the internal combustion engine; and
at least one controller in communication with the internal combustion engine and the at least one actuator;
wherein the at least one controller is configured to:
receive a first input corresponding to an engine speed and a second input corresponding to a measured engine power;
calculate a power loss estimate;
determine a total fueling amount based on the measured engine power and a power loss estimate;
determine a first fuel command for the first fuel associated with the internal combustion engine based on at least a calculated speed governor command and the power loss estimate;
determine at least one updated total fueling amount based on the total fueling amount and the first fuel command for the first fuel;
select a look-up table set associated with the at least one actuator based on a second fuel substitution rate associated with the internal combustion engine, the look-up table set being based on the engine speed and the at least one updated total fueling amount; and
send an input to the at least one actuator based on the look-up table set.

18. The system of claim 17, wherein the at least one controller is further configured to determine an indicated first fuel torque input based on a sum of the friction power estimate and an engine speed torque demand amount, the engine speed torque demand amount corresponding to a difference between the engine speed and an engine speed target.

19. The system of claim 17, wherein the at least one controller is configured to determine the power loss estimate based on a friction torque estimate, an accessory torque estimate, a charge air pumping torque, and the engine speed.

20. The system of claim 17, wherein the at least one controller is further configured to select the look-up table based on a compressor inlet density.

21. A method for controlling a dual fuel engine system configured to operate using a first fuel and a second fuel, the method comprising:
determining a friction power loss amount of an internal combustion engine of the dual fuel engine system, the friction power loss amount being based on an engine speed of the internal combustion engine and a friction torque estimate;
determining an accessory power loss amount of a power of the internal combustion engine, the accessory power loss amount being based on the engine speed and an accessory torque estimate;
estimating a net engine power amount based on the accessory power loss amount and a brake power amount of the internal combustion engine;
estimating an indicated power for the first fuel; and
estimating, based on the estimated net engine power, a first indicated engine power and a first power for the second fuel.

22. The method of claim 21, wherein estimating the indicated power for the first fuel comprises multiplying a determined thermal efficiency correction amount by a determined power estimate for the first fuel.

23. The method of claim 22, wherein determining the power estimate for the first fuel comprises using a first look-up table, the first look-up table being based on a fuel rate for the first fuel and the engine speed.

24. The method of claim 22, wherein determining the thermal efficiency correction amount comprises consulting a first set of look-up tables, the first set of look-up tables being based on at least one of a substitution rate for the second fuel, a knock propensity index, or an intake manifold temperature.

25. The method of claim 22, further comprising determining a lower heating value (LHV) estimate for the second fuel based on the first power for the second fuel, a total second fuel flow estimate, and the thermal efficiency correction amount.

26. The method of claim 25, wherein determining the LHV estimate comprises:
dividing the first power for the second fuel by a multiple of the second fuel flow estimate and the thermal efficiency correction amount to determine an instantaneous LHV amount.

27. The method of claim 26, further comprising applying a learning algorithm to the instantaneous LHV amount to determine the LHV estimate.

28. The method of claim 25, further comprising estimating a second total indicated engine power, wherein estimating the second total indicated engine power comprises:
determining a product of the total flow estimate for the second fuel and the LHV estimate; and
determining a sum of the power estimate for the first fuel and the product of the total second fuel flow and the LHV estimate.

29. The method of claim 28, further comprising determining a difference between the first total indicated engine power and the second total indicated engine power.

30. The method of claim 29, further comprising activating at least one engine protective measure based on the difference between the first total indicated engine power and the second total indicated engine power being greater than a threshold.

31. The method of claim 30, further comprising setting the threshold to correspond to a predetermined period.

32. The method of claim 22, wherein estimating the first power for the second fuel comprises subtracting the indicated power for the first fuel from the indicated engine power.

33. A method for controlling a dual fuel engine system configured to operate using a first fuel and a second fuel, the method comprising:
estimating a net engine power amount of an internal combustion engine of the dual fuel engine system based on an accessory power loss amount of a power of the internal combustion engine, and a brake power estimate of the internal combustion engine;
determining a first total indicated engine power based on the net engine power and a friction power loss amount of the internal combustion engine;
determining a lower heating value (LHV) for the second fuel within the internal combustion engine, the LHV being a measured value or an estimated value;
estimating a second total indicated engine power based on the LHV, a total flow estimate for the second fuel, and a power estimate for the first fuel; and
activating at least one engine protective measure based on a difference between the first total indicated engine power and the second total indicated engine power being greater than a predetermined threshold.

34. The method of claim 33, wherein estimating the second total indicated engine power comprises:
determining a sum of the power estimate for the first fuel and a product of the total second fuel flow and the LHV.

35. The method of claim 33, further comprising:
determining a first power estimate for the second fuel, the first power estimate for the second fuel being based on the first total indicated engine power;
determining a second power estimate for the second fuel, the second power estimate for the second fuel being based on the LHV and a product of a thermal efficiency estimate and the total second fuel flow estimate; and
determining a final second fuel power estimate based on the first power estimate for the second fuel and the second power estimate for the second fuel.

36. The method of claim 35, further comprising estimating a substitution rate for the second fuel, wherein estimating the substitution rate for the second fuel comprises:
dividing the final second fuel power estimate by the first power estimate.

37. A dual fuel engine system operable in a dual fueling mode, comprising:
At least one controller in communication with an internal combustion engine, the internal combustion engine configured to operate using a first fuel and a second fuel;
wherein the at least one controller is configured to:
receive an input corresponding to an engine speed of the internal combustion engine;
receive an input for calculating a net engine power estimate;
calculate a percent rated power of the internal combustion engine based on the engine speed and the net engine power estimate;
determine a base substitution rate target of the second fuel for the internal combustion engine based on the engine speed, the percent rated power, an intake manifold temperature within the internal combustion engine, and a knock propensity index estimate within the internal combustion engine; and
determine a second fuel power target for the internal combustion engine based on the base substitution rate target of the second fuel and a first indicated engine power estimate.

38. The system of claim 37, wherein the controller is configured to determine the base substitution rate target of the second fuel by carrying out the following operations:
determining a first speed base substitution rate target of the second fuel when the engine speed is above a threshold based on the percent rated power, the intake manifold temperature, and the knock propensity index estimate;
determining a second speed base substitution rate target of the second fuel when the engine speed is below the threshold based on the percent rated power, the intake manifold temperature, and the knock propensity index estimate; and
determine the base substitution rate target of the second fuel based on the engine speed, the high speed base substitution rate target of the second fuel, and the low speed base substitution rate target of the second fuel.

39. The system of claim 38, wherein the first speed base substitution rate target of the second fuel is determined based on a first set of look-up tables and the second speed base substitution rate target of the second fuel is determined based on a second set of look-up tables.

40. The system of claim 37, wherein the controller is configured to determine the first indicated engine power based on the net engine power estimate and a friction power loss amount.

41. A method for controlling a dual fuel engine system configured to operate using a first fuel and a second fuel, the method comprising:
determining a flow target of the second fuel for an internal combustion engine of the dual fuel engine system, the flow target of the second fuel being based on a power target of the second fuel of the internal combustion engine, a thermal efficiency estimate of the internal combustion engine, and a lower heating value (LHV) within the internal combustion engine;
adjusting the flow target of the second fuel based on at least one of a measured second fuel temperature or a measured second fuel injector pressure;
determining at least one base second fuel injector command based on the adjusted flow target of the second fuel, a second fuel substitution rate estimate, and a second fuel substitution rate target; and
determining, based on the at least one base second fuel injector command, a second fuel injector command for at least one engine bank.

42. The method of claim 41, further comprising estimating a total second fuel flow based on the measured second fuel injector pressure, the measured second fuel temperature, and the at least one injector command for the second fuel for the at least one engine bank.

43. The method of claim 41, wherein the at least one engine bank comprises a left bank and a right bank, wherein the at least one injector command for the second fuel for the at least one engine bank comprises a left bank second fuel injector command and a right bank second fuel injector command, and determining the left bank second fuel injector command and the right bank second fuel injector command comprises:
biasing the at least one injector command for the second fuel for the at least one engine bank to each of an engine right bank and an engine left bank based on an exhaust temperature difference associated with each of the engine right bank and the engine left bank.

44. The method of claim 43, wherein biasing the at least one base second fuel injector command to each of the engine right bank and an engine left bank comprises:
measuring a left bank exhaust temperature;
measuring a right bank exhaust temperature;
determining a difference between the right bank exhaust temperature and the left bank exhaust temperature;
adding a left bank adjustment amount to the at least one injector command for the second fuel for the at least one engine bank to determine a first adjusted base second fuel injector command based on the difference between the right bank exhaust temperature and the left bank exhaust temperature;
adding a right bank adjustment amount to the at least one injector command for the second fuel for the at least one engine bank to determine a second adjusted base second fuel injector command based on the difference between the right bank exhaust temperature and the left bank exhaust temperature; and
converting each of the first adjusted base second fuel injector command and the second adjusted base second fuel injector command respectively to the left bank second fuel injector command and the right bank second fuel injector command.

45. The method of claim 41, wherein determining the flow target for the second fuel comprises dividing the power target of the second fuel by the thermal efficiency estimate and the LHV.

46. The method of claim 45, wherein the power target of the second fuel is based on a first indicated engine power estimate and the second fuel substitution rate target.

47. The method of claim 41, wherein adjusting the flow target of the second fuel comprises:
calculating an adjusted second fuel flow target amount, the adjusted second fuel flow target amount being a product of the flow target and at least one of a first ratio of the measured second fuel temperature and a temperature reference amount or a second ratio of a measured pressure and a pressure reference amount.

48. The method of claim 47, wherein determining at least one injector command for the second fuel for the at least one engine bank comprises:
determining a feedforward input for a second fuel substitution rate proportional-integral-derivative controller operably coupled to the internal combustion engine, the feedforward input being based on a look-up table referencing at least one of the measured second fuel injector pressure, the measured second fuel temperature, or the adjusted second fuel flow target amount.

49. The method of claim 48, further comprising:
adjusting at least one temperature setpoint for the second fuel based on at least one of a measured knock propensity index or an estimated knock propensity index.

50. The method of claim 49, wherein the at least one temperature setpoint for the second fuel is based on an engine protection setpoint.

51. A dual fuel engine system for an internal combusting engine configured to operate using a first fuel and a second fuel, the dual fuel engine system comprising:
at least one injector for the second fuel operably coupled to the internal combustion engine having a left bank and a right bank, the internal combustion engine being operable in a dual fuel mode; and
at least one proportional-integral-derivative (PID) controller communicably coupled to the internal combustion engine and the at least one injector for the second fuel;
wherein the at least one PID controller is configured to:
receive a feedforward input, a second fuel substitution rate estimate, and a second fuel substitution rate target;
output, based on the feedforward input, at least one injector command for the second fuel; and
bias the at least one injector command for the second fuel to each of the right bank and the left bank based on an exhaust temperature difference associated with each of the right bank and the left bank.

52. The system of claim 51, wherein the at least one PID controller is configured to bias the at least one injector command for the second fuel to each of the right bank and the left bank by carrying out the operations comprising:
measuring a left bank exhaust temperature;
measuring a right bank exhaust temperature;
determining a difference between the right bank exhaust temperature and the left bank exhaust temperature;
adding a left bank adjustment amount to the at least one injector command for the second fuel to determine a first adjusted injector command for the second fuel;
adding a right bank adjustment amount to the at least one injector command for the second fuel to determine a second adjusted injector command for the second fuel; and
converting each of the first adjusted injector command for the second fuel and the second adjusted injector command for the second fuel respectively to the left bank injector command for the second fuel and the right bank injector command for the second fuel.

53. The system of claim 51, wherein the at least one PID controller comprises a first PID controller and a second PID controller, wherein the first PID controller is configured to receive the feedforward input, the second fuel substitution rate estimate, and the second fuel substitution rate target, and wherein the second PID controller is configured to bias the at least one injector command for the second fuel to each of the right bank and the left bank.

54. The system of claim 51, further comprising:
an aftertreatment system operably coupled to the internal combustion engine, the aftertreatment system being a selective catalytic reduction (SCR) and oxidation catalysts (OC) system;
an injection system for the second fuel operably coupled to the internal combustion engine, the injection system for the second fuel including the at least one injector for the second fuel, wherein the injection system for the second fuel is configured to independently control injection of the second fuel on each of the left bank and the right bank; and
an air handling system operably coupled to the internal combustion engine, the air handling system configured to control an air flow through the internal combustion engine independent of an operating condition of the internal combustion engine, wherein the air flow is based on a predetermined value obtained from a look-up table, the predetermined value associated with a target temperature in at least one location of the aftertreatment system.

55. A dual fuel engine system operable in a dual fuel mode, the dual fuel engine system comprising:
an internal combustion engine having at least one engine bank, the internal combustion engine configured to operate using a first fuel and a second fuel;
at least one injector for the second fuel operably coupled to the internal combustion engine; and
at least one controller communicably coupled to the internal combustion engine and the at least one injector for the second fuel;
wherein the at least one controller is configured to:
determine a second fuel flow target for the internal combustion engine, the second fuel flow target being based on a second fuel power target of the internal combustion engine, a thermal efficiency estimate of the internal combustion engine, and a lower heating value (LHV) within the internal combustion engine;
adjust the second fuel flow target based on at least one of a measured second fuel temperature or a measured second fuel injector pressure to determine an adjusted second fuel flow target for the dual fuel mode;
determine at least one base second fuel injector command based on the adjusted second fuel flow target, a substitution rate estimate for the second fuel, and a substitution rate target for the second fuel; and
determine, based on the at least one base second fuel injector command, an injector command for the second fuel for the at least one engine bank.

56. The system of claim 55, wherein the at least one controller is further configured to:
determine, based on the at least one injector command for the second fuel, a left bank second fuel injector command and a right bank second fuel injector command.

57. The system of claim 56, wherein the at least one controller is further configured to determine the second fuel flow target by dividing the second fuel power target by a thermal efficiency estimate and a lower heating value (LHV), wherein the LHV is determined on a look-up table based on an estimated knock propensity index.
